(19) United States
(12) Patent Application Publication
(10) Pub. No.: US 2009/0086000 A1
(43) Pub. Date: Apr. 2, 2009

(54) INK-JET RECORDING DEVICE

(76) Inventor: Yasuyo YOKOTA, Kanagawa (JP)

Correspondence Address: BIRCH STEWART KOLASCH & BIRCH, PO BOX 747, FALLS CHURCH, VA, 22040-0747, US

(21) Appl. No.: 12/239,401

(22) Filed: Sep. 26, 2008

(30) Foreign Application Priority Data
Sep. 28, 2007 (JP) 2007-255773

(51) Int. Cl. B41J 2/01

(52) U.S. Cl. 347/102

(57) ABSTRACT

The ink-jet recording device includes an image forming section where an active energy ray-curable ink is ejected onto a recording medium to form an image, and an image curing section which includes at least one light irradiation unit having a fluorescent lamp and which cures the ink on the recording medium upon exposure to active energy rays. The fluorescent lamp has a bulb, a reflective film formed on a bulb inner wall and having a first aperture formed on a recording medium side, and a phosphor film formed on the reflective film and the bulb inner wall and having a second aperture formed on the recording medium side. The formulas: β<α, 60°≦α≦150° and 30°≦β≦90° where α represents a first aperture angle of the first aperture and β represents a second aperture angle of the second aperture are satisfied.

The entire contents of all documents cited in this specification are incorporated herein by reference.

### BACKGROUND OF THE INVENTION

The present invention belongs to the field of ink-jet recording, and more specifically relates to an ink-jet recording device with which ink that cures upon exposure to active rays is ejected onto a recording medium to form an image thereon.

One method of forming images on a recording medium involves image formation by ejecting ink droplets from an ink-jet head.

An exemplary device for forming an image with an ink-jet head includes an ink-jet recording device in which an active energy ray-curable ink that cures upon exposure to active energy rays is ejected from an ink-jet head onto a recording medium and is cured by exposure to the active energy rays. Such ink-jet recording device using an active energy ray-curable ink has various advantages: It is an environmentally-friendly device; high-speed recording on various recording media is possible; what is more, bleeding is not likely to occur to enable high-definition images to be recorded.

An example of the ink-jet recording device that uses an ink which is curable upon exposure to active energy rays includes an image recording device described in JP 2004-299296 A which includes recording heads each having nozzles for ejecting light-curable ink therefrom and light irradiators which are disposed downstream of the corresponding recording heads in a direction of travel of a recording medium and irradiates the ink deposited onto the recording medium with light to cure the deposited ink. Each of the light irradiators includes a light source and a reflective member on which light from the light source is reflected to travel toward a predetermined light irradiation position on the recording medium. The inside area of the aperture of the reflective member which faces the recording medium is irradiated with the light reflected on the reflective member.

Although not directed to an ink-jet recording device, JP 2006-310084 A describes a light-emitting fluorescent lamp including a tubular bulb, a light-reflecting layer which is formed on the inner surface of the bulb along the tubular bulb axis substantially over the half of the circumferential surface of the bulb and serves to reflect part of visible light, and a phosphor layer which is formed on the bulb inner surface except an aperture formed in the inner surface region of the bulb and on the light-reflecting layer so that the aperture is formed in the inner surface region of the bulb facing the light-reflecting layer. According to JP 2006-310084 A, it is preferable for the aperture of the reflecting film to be formed so that the angle of aperture from the bulb axis is 180±20° and for the aperture of the phosphor layer to be formed so that the angle of aperture from the bulb axis is in the range of 20° to 120°.

### SUMMARY OF THE INVENTION

Prints can be produced at a high rate in a so-called single pass ink-jet recording device in which an elongated recording medium capable of high-speed transport is used, an ink-jet head having an enough width to enable recording on the whole area in the width direction of the recording medium is fixed at an opposed position to the recording medium (or its travel path), and recording is accomplished by passing the recording medium under the ink-jet head only once.

In the case where color printing is carried out with such a single pass ink-jet recording device, fixed heads whose number corresponds to the number of colors are disposed in the direction of travel of the recording medium, and by disposing the light irradiating means downstream of the heads for the respective colors as in the ink-jet recording device described in JP 2004-299296 A, inks of different colors are prevented from intermingling. However, even if the light irradiating means are disposed downstream of the heads for the respective colors, deposition interference that adjacent dots are merged together on a recording medium or on ink cured after ejection from an ink-jet head disposed further upstream in the direction of travel of the recording medium, may occur to lower the image quality.

In the case of producing a print having an image formed thereon at a high rate, a higher irradiation intensity is required to cure ink in a short period of time.

However, light irradiating means having a high irradiation intensity is expensive and therefore involves an increased device cost.

The fluorescent lamp described in JP 2006-310084 A that has the light-reflecting layer is capable of further illuminating the same area than before being provided with the light-reflecting layer, but sufficient exposure is not achieved when light is irradiated for a short period of time.

In addition, if the irradiation intensity of the light irradiating means (or the fluorescent lamp) or the sensitivity to curing of the ink is increased in view of the improvement of the productivity, the ink-jet head nozzles are likely to be clogged.

The present invention has been accomplished with a view to solving the above-mentioned problems of the prior art and an object of the present invention is to provide an inexpensive, compact ink-jet recording device that is capable of consistently and rapidly producing prints having high-resolution and high-quality images formed therein for an extended period of time and also capable of reducing the maintenance frequency.

In order to achieve the above object, a first aspect of the invention provides an ink-jet recording device comprising: transport means for transporting a recording medium; image forming means which includes at least one ink-jet head that ejects, based on image signals, ink containing at least a colorant and cured by exposure to active energy rays onto the recording medium transported by the transport means and moved to a position opposed to the at least one ink-jet head; and image curing means which includes at least one light irradiation unit having a fluorescent lamp from which the active energy rays are emitted, and which cures the ink deposited on the recording medium by irradiation of an image formed on the recording medium with the active energy rays from the at least one light irradiation unit, wherein the fluorescent lamp has a bulb, a reflective film formed on a large part of an inner wall of the bulb and having a first aperture formed on a side of the recording medium, and a phosphor film formed on the reflective film and a part of the inner wall of the bulb and having a second aperture formed on the side of the recording medium, and wherein formulas: β<α, 60°≦α≦150° and 30°≦β≦90° where α represents a first aperture angle of the first aperture for the reflective film and β represents a second aperture angle of the second aperture for the phosphor film, are satisfied.

In the ink-jet recording device of the first aspect, the reflective film preferably has a transmittance of not more than 10%.

In order to achieve the above object, a second aspect of the invention provides an ink-jet recording device comprising: transport means for transporting a recording medium; image forming means which includes at least one ink-jet head that ejects, based on image signals, ink containing at least a colorant and cured by exposure to active energy rays onto the recording medium transported by the transport means and moved to a position opposed to the at least one ink-jet head; and image curing means which includes at least one light irradiation unit having a fluorescent lamp from which the active energy rays are emitted, and which cures the ink deposited on the recording medium by irradiation of an image formed on the recording medium with the active energy rays from the at least one light irradiation unit, wherein the fluorescent lamp has a bulb, a reflective film formed on a large part of an inner wall of the bulb and having a first aperture formed on a side of the recording medium, and a phosphor film formed on the reflective film and a part of the inner wall of the bulb and having a second aperture formed on the side of the recording medium, and wherein the reflective film has a transmittance of not more than 10%.

In the ink-jet recording devices of the first and second aspects, the first aperture of the reflective film and the second aperture of the phosphor film are preferably symmetric with respect to a axial plane connecting a centre of the fluorescent lamp with the recording medium.

It is preferable for the at least one light irradiation unit to further include a housing which is disposed so as to surround the fluorescent lamp and has an opening formed on the side of the recording medium.

The at least one ink-jet head is preferably of a full-line type in which the at least one ink-jet head has a length in a direction perpendicular to a direction of travel of the recording medium which is larger than a width of the recording medium and ink droplets can be ejected over a whole area of the recording medium in the direction perpendicular to the direction of travel of the recording medium.

Preferably, the at least one ink-jet head of the image forming means comprises at least two ink-jet heads from which inks of different colors are ejected, and the at least one light irradiation unit of the image curing means comprises at least one light irradiator disposed between adjacent ink-jet heads of the at least two ink-jet heads in a direction of travel of the recording medium and a final light irradiator which irradiates the active energy rays onto images formed on the recording medium.

The final light irradiator is preferably configured as in the at least one light irradiator.

The final light irradiator preferably comprises a metal halide lamp or a high-pressure mercury vapor lamp.

Preferably, the at least one light irradiator disposed between the adjacent ink-jet heads of the at least two ink-jet heads semi-cures ink constituting an image formed by an ink-jet head located upstream of the at least one light irradiator in the direction of travel of the recording medium, and the final light irradiator cures inks of the images formed on the recording medium.

It is preferable for the ink-jet recording device to further comprise undercoating liquid applying means which is disposed upstream from the image forming means in a direction of travel of the recording medium transported by the transport means and which applies to the recording medium undercoating liquid that cures upon exposure to the active energy rays; and undercoating liquid semi-curing means which is disposed downstream of the undercoating liquid applying means in the direction of travel of the recording medium and which includes a light irradiation unit, the undercoating liquid applied onto the recording medium being irradiated with active energy rays from the light irradiation unit to semi-cure the undercoating liquid applied on the recording medium.

According to the invention, by providing the fluorescent lamp with a reflective film and a phosphor film each having an aperture formed therein and by forming the apertures so as to have such shapes that the aperture angles satisfy the above-defined ranges or setting the transmittance of the reflective film to not more than 10%, the recording medium side can be irradiated with high intensity light while reducing the intensity of light traveling in other directions even in the case where the fluorescent lamp used is inexpensive.

An image can be thus cured to a desired state even in the case where the recording medium travels at a high speed. Light is prevented from reaching the ink-jet head to cause nozzle clogging or this phenomenon is suppressed to enable the maintenance frequency to be reduced.

As a result, prints having high-resolution and high-quality images formed therein can be rapidly produced for a long time in a consistent manner. Use of the fluorescent lamp enables the light irradiation unit and hence the device to be manufactured at a low cost. Provision of the reflective film within the bulb of the fluorescent lamp enables the light irradiation unit and hence the image curing means to be downsized because it is not necessary to provide space for disposing a reflective member such as a reflector on the circumference of the fluorescent lamp.

A higher-resolution and higher-quality image can be formed by applying the undercoating liquid onto the recording medium and semi-curing the applied undercoating liquid.

### BRIEF DESCRIPTION OF THE DRAWINGS

In the accompanying drawings:

FIG. 1 is a front view schematically showing the structure of an embodiment of an ink-jet recording device according to the invention;

FIG. 2A is a longitudinal sectional view schematically showing the structure of an exemplary fluorescent lamp used in UV irradiation units of the ink-jet recording device shown in FIG. 1;

FIG. 2B is a sectional view, taken along the line B-B, of the fluorescent lamp shown in FIG. 2A;

FIG. 3 is a schematic sectional view of a recording medium where ink droplets have been deposited onto a semi-cured undercoating liquid;

FIGS. 4A and 4B are schematic sectional views of recording media where ink droplets have been deposited onto an undercoating liquid that is in an uncured state;

FIG. 4C is a schematic sectional view of a recording medium where ink droplets have been deposited onto an undercoating liquid that is in a completely cured state;

FIG. 5 is a schematic sectional view of a recording medium where ink droplets have been deposited onto a semi-cured ink liquid;

FIGS. 6A and 6B are schematic sectional views of recording media where ink droplets have been deposited onto an ink liquid that is in an uncured state;

FIG. 6C is a schematic sectional view of a recording medium where ink droplets have been deposited onto an ink liquid that is in a completely cured state;

FIGS. 7A to 7D are schematic diagrams showing steps in the formation of an image on a recording medium;

FIG. 8 is a front view showing, in simplified form, an embodiment of a digital label printer which uses the ink-jet recording device of the invention; and

FIG. 9 is a longitudinal sectional view of a recording medium for printing labels such as may be used in the digital label printer shown in FIG. 8.

### DETAILED DESCRIPTION OF THE INVENTION

The ink-jet recording device according to the present invention is described more fully below based on the embodiments shown in the accompanying diagrams.

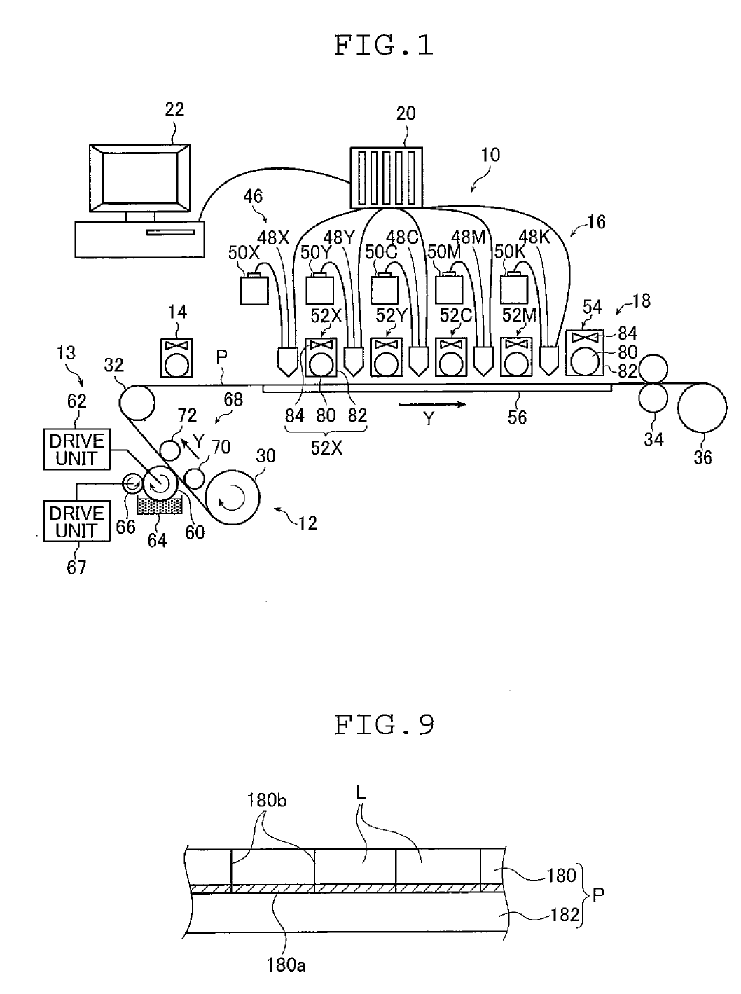

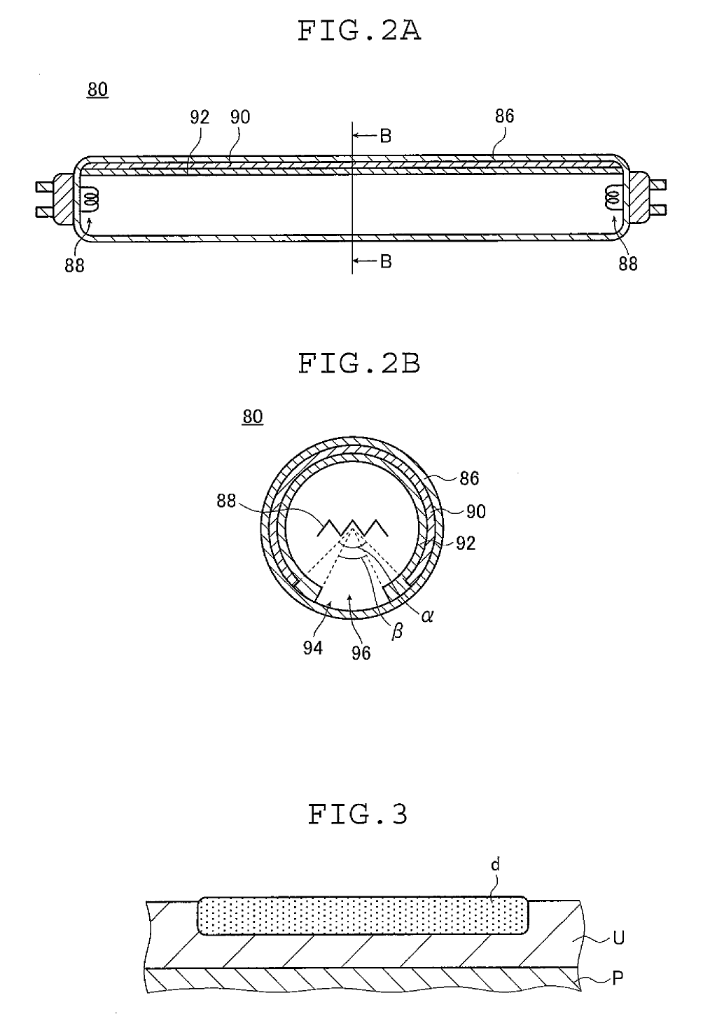

FIG. 1 is a front view schematically showing the structure of an embodiment of an ink-jet recording device according to the invention; FIG. 2A is a longitudinal sectional view schematically showing the structure of an exemplary fluorescent lamp used in UV irradiation units of the ink-jet recording device shown in FIG. 1; and FIG. 2B is a sectional view, taken along the line B-B, of the fluorescent lamp shown in FIG. 2A.

In the embodiments described below, active light-curable ink-jet recording devices which use an ultraviolet light-curable ink (UV-curable ink) as the active light-curable ink (also referred to as “active energy ray-curable ink”) that cures under irradiation with active light (also referred to as “active energy rays”) are described below. However, the invention is not limited to this and may apply to ink-jet recording devices in which various types of active light-curable inks are used. Examples of the active light that may be used in the invention include UV light and visible light.

As shown in FIG. 1, an ink-jet recording device 10 has a transport section 12 which transports a recording medium P, an undercoat forming section 13 which coats an undercoating liquid onto the recording medium P, an undercoating liquid semi-curing section 14 which semi-cures the undercoating liquid that has been coated onto the recording medium P, an image recording section 16 which records an image on the recording medium P, an image fixing section 18 which fixes the image recorded on the recording medium P, and a control unit 20 which controls the ejection of ink droplets from the image recording section 16.

An input unit 22 is connected to the control unit 20 of the ink-jet recording device 10. The input unit 22 may be an image reading unit such as a scanner or any of various types of devices which transmit image data, including image processing devices such as a personal computer. Any of various connection methods, whether wired or wireless, may be used to connect the input unit 22 and the control unit 20.

The transport section 12, which has a feed roll 30, a transport roll 32, a transport roller pair 34 and a recovery roll 36, feeds, transports and recovers the recording medium P.

The feed roll 30 has a web-type recording medium P wrapped thereon in the form of a roll, and feeds the recording medium P.

The transport roll 32 is disposed on the downstream side of the feed roll 30 in the direction of travel of the recording medium P, and transports the recording medium P that has been let out from the feed roll 30 to the downstream side in the direction of travel.

The transport roller pair 34 is a pair of rollers which are disposed on the downstream side of the transport roll 32 in the travel path of the recording medium P and which grip therebetween the recording medium P that has passed around the transport roll 32 and transport it to the downstream side in the direction of travel.

The recovery roll 36 is disposed the furthest downstream on the travel path of the recording medium P. The recovery roll 36 takes up the recording medium P which has been fed from the feed roll 30, has been transported by the transport roll 32 and the transport roller pair 34, and has passed through positions facing the subsequently described undercoat forming section 13, undercoating liquid semi-curing section 14, image recording section 16 and image fixing section 18.

Here, the transport roll 32, the transport roller pair 34 and the recovery roll 36 are connected to drive units (not shown) and rotated by the drive units.

Here, the transport roll 32 is disposed above the feed roll 30 in a vertical direction, and at a position farther from the recovery roll 36 than from the feed roll 30 in a horizontal direction. Moreover, the transport roll 32, the transport roller pair 34 and the recovery roll 36 are disposed linearly in a direction parallel to the horizontal direction.

The transport section 12 is configured as described above and transports the recording medium P let out from the feed roll 30 upward while inclined at a given angle with respect to the vertical direction toward the side away from the recovery roll 36, following which the transport section 12 changes the direction of travel of the recording medium P at the transport roll 32 so that, after the recording medium P has passed the transport roll 32, it is transported horizontally toward the recovery roll 36.

In other words, after the recording medium P has been let out from the feed roll 30, it is moved in an upwardly inclined direction with the surface on which images are to be recorded facing downward. After passing around the transport roll 32, the recording medium P is moved in a horizontal direction with the surface on which images are to be recorded facing upward.

The undercoat forming section 13 is situated between the feed roll 30 and the transport roll 32; that is, on the downstream side of the feed roll 30 and on the upstream side of the transport roll 32 in the direction of travel of the recording medium P.

The undercoat forming section 13 has a coating roll 60 for coating an undercoating liquid onto the recording medium P, a drive unit 62 which drives the coating roll 60, a reservoir 64 which supplies the undercoating liquid to the coating roll 60, a scraper roll 66 which adjusts the amount of undercoating liquid picked up by the coating roll 60, a scraper roll drive unit 67 which drives the scraper roll 66 (hereinafter referred to simply as the “drive unit 67”) and a positioning unit 68 which supports the recording medium P so that the recording medium P assumes a predetermined position relative to the coating roll 60.

The coating roll 60 is disposed between the feed roll 30 and the transport roll 32 in the travel path of the recording medium P so as to be in contact with the surface of the recording medium P which is traveling between the feel roll 30 and the transport roll 32 and on which images are to be formed. That is, the coating roll 60 is in contact with the downwardly facing surface of the recording medium P being transported from the feed roll 30 to the transport roll 32.

The coating roll 60, which is a roll that is longer than the width of the recording medium P, is a so-called gravure roller on the surface (peripheral face) of which recessed features are formed at fixed, i.e., uniform, intervals. Here, the shapes of the recessed features formed on the coating roll 60 are not subject to any particular limitation. Any of various shapes may be used, including round, rectangular, polygonal or star-like shapes. Alternatively, the recessed features may be formed as grooves extending over the entire circumference of the coating roll. Since the amount of undercoating liquid held on the surface of the coating roll 60 can be made constant, the coating roll 60 preferably has such a shape that recessed features are formed on its surface at fixed intervals. However, this is not the sole case of the present invention but a roll having no recessed features formed thereon may also be used.

The drive unit 62 is a drive mechanism including a motor, and gears which transmit rotation of the motor to the coating roll 60 and rotates the coating roll 60. However, the drive unit 62 is not limited to this embodiment. Any of various other drive mechanisms may instead be used to rotate the coating roll 60, including pulley driving, belt driving and direct driving.

As indicated by an arrow in FIG. 1, the drive unit 62 causes the coating roll 60 to rotate in the direction opposite to the direction of travel of the recording medium P at the portion of contact therebetween (i.e., in the clockwise direction in FIG. 1).

The reservoir 64 has a dish-like shape open at the top, and holds in the interior thereof the undercoating liquid. The reservoir 64 is disposed underneath and adjacent to the coating roll 60, such that a portion of the coating roll 60 is immersed in the undercoating liquid held within the reservoir 64. When necessary, the undercoating liquid is fed to the reservoir 64 from a feed tank (not shown).

The scraper roll 66 is a roll having substantially the same axial length as the coating roll 60. The scraper roll 66 is rotatably disposed in a state in which it is in contact with the surface of the coating roll 60. More specifically, the scraper roll 66 is disposed downstream of the reservoir 64 and upstream of the recording medium P in the rotational direction of the coating roll 60.

The scraper roll 66 scrapes off that portion of the undercoating liquid picked up by the coating roll 60 when immersed in the reservoir 64 which is not needed, thereby setting the quantity of undercoating liquid adhering to the coating roll 60 to a fixed amount. In this embodiment, except for the undercoating liquid retained in the recessed features formed on the surface of the coating roll 60, the scraper roll 66 scrapes off undercoating liquid adhering to other portions of the coating roll 60 so that the portion of the coating roll 60 which comes in contact with the recording medium P has the undercoating liquid substantially only held in the recessed features.

The scraper roll 66 scrapes off undercoating liquid excessively adhering to the surface of the coating roll 60 (i.e., surplus undercoating liquid) to make the amount of undercoating liquid adhering to the surface of the coating roll 60 constant, thus enabling the coating layer to be more uniformly formed on the recording medium.

As shown by an arrow in FIG. 1, the drive unit 67 rotates the scraper roll 66 in the opposite direction from the rotational direction of the coating roll 60 so that the direction of movement of the scraper roll 66 surface and the direction of movement of the coating roll 60 at the position of contact between the scraper roll 66 and the coating roll 60 are the same (in the counterclockwise direction in FIG. 1). As in the drive unit 62, various drive mechanisms may be used to rotate the roll, including gear driving, pulley driving, belt driving and direct driving. The drive unit 67 rotates the scraper roll 66 in the opposite direction from the rotational direction of the coating roll 60 to prevent abrasion of the scraper roll 66 and the coating roll 60, thus enabling their replacement frequency to be reduced while enhancing the device durability.

Since the device can have a higher durability, undercoating liquid excessively adhering to the coating roll 60 is preferably scraped off by a scraper roll as in the embodiment under consideration. However, this is not the sole case of the present invention but use may be made of a method using a blade in which the blade is brought into contact with the coating roll 60 to scrape off undercoating liquid excessively adhering to the coating roll 60.

The positioning unit 68 has a first positioning roll 70 and a second positioning roll 72, and supports the recording medium P in such a way as to ensure that the recording medium P comes into contact with the coating roll 60 at a specified position.

The first and second positioning rolls 70 and 72 are each situated on the opposite side of the recording medium P from the coating roll 60 and, in the direction of travel of the recording medium P, on either side of the coating roll 60; that is, one is situated on the upstream side, and the other is situated on the downstream side, of the coating roll 60. These first and second positioning rolls 70 and 72 support the recording medium P from the side of the recording medium P opposite to the side on which images are to be formed (i.e., the side to be coated with undercoating liquid).

It is preferable to provide a positioning mechanism for fixing the mutual positions of the coating roll 60, the first positioning roll 70 and the second positioning roll 72 in the undercoat forming section 13. By thus providing the positioning mechanism, departures from the correct positional relationships between the coating roll 60 and the positioning rolls 70 and 72 can be prevented from occurring.

Any positioning mechanism may be used as long as it is configured such that members which individually support the coating roll 60 and the first and second positioning rolls 70 and 72 are placed in mutual contact. For example, use may be made of a mechanism in which the bearings of the respective members are placed in mutual contact, and a mechanism in which fixing members which fix in place the bearings are placed in mutual contact.

In the foregoing arrangement of the undercoat forming section 13, the drive unit 62 causes the coating roll 60 to rotate in the direction opposite to the direction of travel of the recording medium P. After being immersed in the undercoating liquid which has accumulated in the reservoir 64, the surface of the rotating coating roll 60 comes into contact with the scraper roll 66, thereby setting the amount of undercoating liquid retained on the surface to a fixed amount, then comes into contact with the recording medium P, thereby coating the undercoating liquid onto the recording medium P. By thus rotating the coating roll 60 in the direction opposite to the direction of travel of the recording medium P and coating the undercoating liquid onto the recording medium P, a layer of undercoating liquid (referred to below as the “undercoat”) that has been smoothened and has a good, even, coating surface state can be formed on the recording medium P. The coating roll 60 that came into contact with the recording medium P is further rotated to be immersed again in the coating liquid within the reservoir 64.

Next, the undercoating liquid semi-curing section 14 is described.

The undercoating liquid semi-curing section 14 includes a UV irradiation unit and is disposed so as to face the recording medium P.

The UV irradiation unit has a fluorescent lamp emitting UV light, a housing which is disposed so as to surround the fluorescent lamp, has an opening formed on the recording medium P side and reflects light emitted from the fluorescent lamp, and a cooling mechanism which is disposed in the housing and blows air to the fluorescent lamp for its cooling, and irradiates UV light onto the recording medium P. The UV irradiation unit will be described later in detail in connection with the image fixing section 18.

The undercoating liquid semi-curing section 14 exposes to UV light the entire width of the recording medium P which has been coated on the surface with the undercoating liquid and passes through a position opposed thereto, thereby rendering the undercoating liquid coated onto the surface of the recording medium P into a semi-cured state. Semi-curing of the undercoating liquid will be described later in further detail.

Next, the image recording section 16 in which ink droplets are ejected onto the recording medium to record an image and the image fixing section 18 in which the image formed on the recording medium in the image recording section 16 is cured to fix it on the recording medium are described.

The image recording section 16 has a recording head unit 46 and ink tanks 50X, 50Y, 50C, 50M and 50K.

The recording head unit 46 has recording heads 48X, 48Y, 48C, 48M and 48K.

The recording heads 48X, 48Y, 48C, 48M and 48K are arranged in this order from the upstream side to the downstream side in the direction of travel of the recording medium P. Moreover, in the recording heads 48X, 48Y, 48C, 48M and 48K, the tips of the respective ink ejection portions are disposed so as to face the path of travel of the recording medium P; that is, so as to face the recording medium P which is transported over the travel path by the transport section 12 (also referred to below as simply “facing the recording medium P”).

The recording heads 48X, 48Y, 48C, 48M and 48K are full-line, piezoelectric ink-jet heads in which a large number of orifices (nozzles, ink ejection portions) are arranged at fixed intervals throughout in a direction perpendicular to the direction of travel of the recording medium P, that is, over the entire width of the recording medium P. These recording heads are connected to the subsequently described control unit 20 and the ink tanks 50X, 50Y, 50C, 50M and 50K. The amount of ink droplets ejected by the recording heads 48X, 48Y, 48C, 48M and 48K and the ejection timing of the droplets are controlled by the control unit 20. The recording heads 48X, 48Y, 48C, 48M and 48K eject inks of special color (X), yellow (Y), cyan (C), magenta (M) and black (K).

A color image can be formed on the recording medium P by ejecting inks of various colors—special color (X), yellow (Y), cyan (C), magenta (M) and black (K)—from the respective recording heads 48X, 48Y, 48C, 48M and 48K toward the recording medium P while at the same time having the transport section 12 transport the recording medium P.

In the present embodiment, the recording heads are piezoelectric (piezo) elements. However, the invention is not limited in this regard. Any of various types of systems may be used in place of a piezo system, such as a thermal jet system which uses a heating element such as a heater to heat the ink and generate bubbles. In this latter system, the pressure of the bubbles propels the droplets of ink.

Any of various inks, such as white, orange, violet or green ink may be used as the special colored ink ejected from the recording head 48X. The number of inks ejected from the recording head 48X is not limited to one but a plurality of inks may be ejected therefrom. As for the order in which the recording heads 48X, 48Y, 48C, 48M and 48K are arranged, this embodiment is not the sole case but the recording heads may be arranged in various orders.

The inks ejected from the recording heads in the present embodiment are UV-curable inks.

The ink tanks 50X, 50Y, 50C, 50M and 50K are provided for the recording heads 48X, 48Y, 48C, 48M and 48K. The respective ink tanks 50X, 50Y, 50C, 50M and 50K store inks of various colors for the recording heads, and supplies the stored inks to the corresponding recording heads 48X, 48Y, 48C, 48M and 48K.

In addition, a tabular platen 56 is disposed at a position facing the recording heads 48X, 48Y, 48C, 48M and 48K on the side of the recording medium P where images will not be formed.

The platen 56 supports the recording medium P which is transported through positions facing the respective recording heads from the side of the recording medium P on which images will not be formed; that is, from the opposite side of the recording medium P to that on which the recording head unit 46 is disposed. In this way, the distance between the recording medium P and the respective recording heads can be made constant, enabling high-resolution images to be formed on the recording medium P.

The shape of the platen 56 is not limited to a flat plate, and may have a raised, curved surface shape on the recording head side. In such a case, the recording heads 48X, 48Y, 48C, 48M and 48K are disposed at fixed distances from the platen.

Then, the image fixing section 18, which has UV irradiation units 52X, 52Y, 52C and 52M, and a final UV irradiation unit for curing 54, irradiates UV light onto the image formed on the recording medium P by the recording head unit 46, thereby semi-curing the image (that is, the inks) with the UV irradiation units 52X, 52Y, 52C and 52M, then curing it with the final UV irradiation unit for curing 54, thus fixing the image.

The UV irradiation units 52X, 52Y, 52C and 52M are disposed on the downstream sides of the respective recording heads 48X, 48Y, 48C and 48M along the travel path of the recording medium P. In addition, the final UV irradiation unit for curing 54 is disposed on the downstream side of the recording head 48K along the travel path of the recording medium P. That is, the final UV irradiation unit for curing 54 is positioned on the downstream side of the recording head situated the furthest downstream of all the recording heads along the travel path of the recording medium P.

In other words, as shown in FIG. 1, the respective recording heads 48X, 48Y, 48C, 48M and 48K, the respective UV irradiation units 52X, 52Y, 52C and 52M, and the final UV irradiation unit for curing 54 are disposed in the following order, from the upstream to the downstream side of the travel path: recording head 48X, UV irradiation unit 52X, recording head 48Y, UV irradiation unit 52Y, recording head 48C, UV irradiation unit 52C, recording head 48M, UV irradiation unit 52M, recording head 48K, final UV irradiation unit for curing 54.

Here, the UV irradiation units 52X, 52Y, 52C and 52M and the final UV irradiation unit for curing 54 differ only in the size of the units, the target to be irradiated with UV light and the degree of cure. Specifically, the UV irradiation units 52X, 52Y, 52C and 52M semi-cure the images formed by the respective recording heads, whereas the final UV irradiation unit for curing 54 differs only in that it irradiates higher intensity light than the other UV irradiation units so as to reliably cure both the undercoating liquid coated onto the recording medium P and images of all the respective inks. Because the final UV irradiation unit for curing 54 has the same basic construction as the UV irradiation units 52X, 52Y, 52C and 52M, the description given below for the UV irradiation unit 52X applies collectively to all of the above UV irradiation units, including the final UV irradiation unit for curing 54.

Now, the UV irradiation unit 52X is described with reference to FIGS. 1, 2A and 2B.

The UV irradiation unit 52X has a fluorescent lamp 80 emitting UV light, a housing 82 which is disposed so as to surround the fluorescent lamp 80 and which has an opening formed on the recording medium P side, and a cooling mechanism 84 which is disposed within the housing 82 and which blows air to the fluorescent lamp 80 for its cooling. The UV irradiation unit 52X is disposed so as to face the travel path of the recording medium P.

The fluorescent lamp 80 is a linear light source which emits UV light and is disposed so that a direction orthogonal to the direction of travel of the recording medium P is parallel to the axial direction in which the fluorescent lamp 80 extends. The fluorescent lamp 80 has a length which is larger than that of the recording medium P in the width direction, and is disposed over the entire width of the recording medium P.

As shown in FIGS. 2A and 2B, the fluorescent lamp 80 has a bulb 86, electrodes 88, a reflective film 90, and a phosphor film 92.

The bulb 86 is a tubular (or cylindrical) member made of a material such as soda glass or fused silica (sterile glass). Tubes having a length in the range of from 500 mm to 800 mm may be used for the bulb 86. Tubes having diameters of 15.5 mm, 20 mm, 25.5 mm, 28 mm, 32 mm, and 38 mm may be used for the bulb 86.

The electrodes 88 protrude into the space formed in the bulb 86, have each a filament through which electric current flows, and are disposed at both ends of the bulb 86.

The bulb 86 and the electrodes 88 at both ends of the bulb 86 are disposed so as to hermetically seal the bulb 86, and mercury or other material is sealed within the bulb 86.

The reflective film 90 is made of a light reflective material and is formed on the inner wall surface of the bulb 86.

The phosphor film 92 is made of a phosphor which emits UV light at 280 to 400 nm, and is formed on the reflective film 90 and part of the inner wall surface of the bulb 86.

In this way, the fluorescent lamp 80 is of a structure in which the bulb 86, the reflective film 90 and the phosphor film 92 are stacked on top of each other from the outside toward the center of the fluorescent lamp 80.

In addition, as shown in FIG. 2B, neither the reflective film 90 nor the phosphor film 92 is formed on the bulb 86 on the recording medium P side (on the bottom side in FIG. 2B) and these portions corresponding to the reflective film 90 and the phosphor film 92 are hereinafter referred to as apertures 94 and 96, respectively.

The reflective film 90 and the phosphor film 92 have shapes satisfying the conditions: β<α, 60°≦α≦150° and 30°≦β≦90° wherein α represents the aperture angle of the aperture 94 for the reflective film 90 and β represents the aperture angle of the aperture 96 for the phosphor film 92. The aperture angle as used herein refers to an angle formed between a first line segment that connects the center of the section of the fluorescent lamp which is orthogonal to the longitudinal direction (i.e. the center of the reflective film 90 or the phosphor film 92 formed on the circumference of the bulb 86) and a first aperture end, and a second line segment that connects the center of the section and a second aperture end.

Since the condition of β<α is satisfied, the fluorescent lamp 80 has, on the recording medium P side of the bulb 86, a first region where both of the reflective film 90 and the phosphor film 92 are not formed on the bulb 86 and a second region where the phosphor film 92 is only formed thereon. In other words, the bulb 86 has the second region where the phosphor film 92 is directly formed on the bulb 86.

The fluorescent lamp 80 has the arrangement as described above. When the filaments of the electrodes 88 are preheated by application of electric current, electrons are released from emitters having an elevated temperature (emitters being coated on the filaments) to collide with mercury atoms sealed within the fluorescent lamp 80. Mercury generates UV light. Then, upon exposure to the thus generated UV light, the phosphor film 92 emits light at the respective wavelengths. The emitted light then travels through the aperture 94 toward the recording medium P directly or after having been reflected on the reflective film 90.

The housing 82 is in the shape of a rectangular parallelepiped box and is disposed so as to surround the periphery of the fluorescent lamp 80. The housing 82 has an open surface on the side of the recording medium P. In other words, the surface of the housing 82 on the recording medium P side is opened and light emitted from the fluorescent lamp 80 passes through the opened surface to strike on the recording medium P.

The cooling mechanism 84 is an air blowing machine such as a cooling fan or an air blower, and is disposed within the housing 82 on the side of the fluorescent lamp 80 away from the recording medium P (i.e., on the upper side of the fluorescent lamp 80 in FIG. 1). The cooling mechanism 84 blows air toward the fluorescent lamp 80 for its cooling.

The cooling mechanism 84 also has a temperature sensor for detecting the temperature of the fluorescent lamp 80. The volume of air and the time of air blowing are adjusted to regulate the amount of cooling thereby maintaining the fluorescent lamp 80 at a constant temperature.

An opening is preferably formed in the housing 82 so that air to be blown from the cooling mechanism 84 to the fluorescent lamp 80 is aspirated through the opening.

The UV irradiation unit 52X is basically configured as described above.

Next, the control unit 20 is connected to the respective recording heads 48X, 48Y, 48C, 48M and 48K of the recording head unit 46 and, using image data sent from the input unit 22 as the image recording signals, controls ink ejection/non-ejection from the respective recording heads 48X, 48Y, 48C, 48M and 48K so as to form images on the recording medium P.

The ink-jet recording device 10 has the basic layout as described above.

Semi-curing the undercoating liquid and ink is now described.

In the practice of the invention, the term “semi-curing the undercoating liquid” as used herein signifies partial curing, and refers to the undercoating liquid in a partially cured, i.e., an incompletely cured, state. When the undercoating liquid that has been applied onto the recording medium (base material) P is semi-cured, the degree of curing may be non-uniform; preferably, the degree of curing proceeds in the depth direction of the undercoating liquid. In the present embodiment, the undercoating liquid which is semi-cured is an undercoating liquid which forms an undercoat.

For example, when a radical-polymerizable undercoating liquid is cured in air or air that is partially flushed with an inert gas, due to the radial polymerization-suppressing effect of oxygen, radical polymerization tends to be inhibited at the surface of the undercoating liquid. As a result, semi-curing is non-uniform, there being a tendency for curing to proceed at the interior of the undercoating liquid and to be delayed at the surface.

In the practice of the invention, by using a radical-photopolymerizable undercoating liquid in the presence of oxygen which tends to inhibit radical polymerization, the undercoating liquid partially photocures, enabling the degree of cure of the undercoating liquid to be higher at the interior than at the exterior.

Alternatively, in cases where a cationic-polymerizable undercoating liquid is cured in air containing humidity, because moisture has a cationic polymerization-inhibiting effect, there is a tendency for curing to proceed at the interior of the undercoating liquid and to be delayed at the surface.

It is likewise possible for the degree of cure in the undercoating liquid to be made higher at the interior than at the exterior by using this cationic-polymerizable undercoating liquid under humid conditions that have a cationic polymerization-inhibiting effect so as to induce partial photocuring.

By thus semi-curing the undercoating liquid and depositing ink droplets on the semi-cured undercoating liquid, technical effects that are advantageous for the quality of the resulting print can be achieved. The mechanism of action can be confirmed by examining a cross-section of the print.

The semi-curing of the undercoating liquid (i.e., the undercoat formed of undercoating liquid on the recording medium) is described in detail below. As one illustration, high-density areas obtained by depositing about 12 pL of liquid ink (that is, droplets of ink) on the undercoating liquid in a semi-cured state having a thickness of about 5 μm that has been provided on a recording medium P are described below.

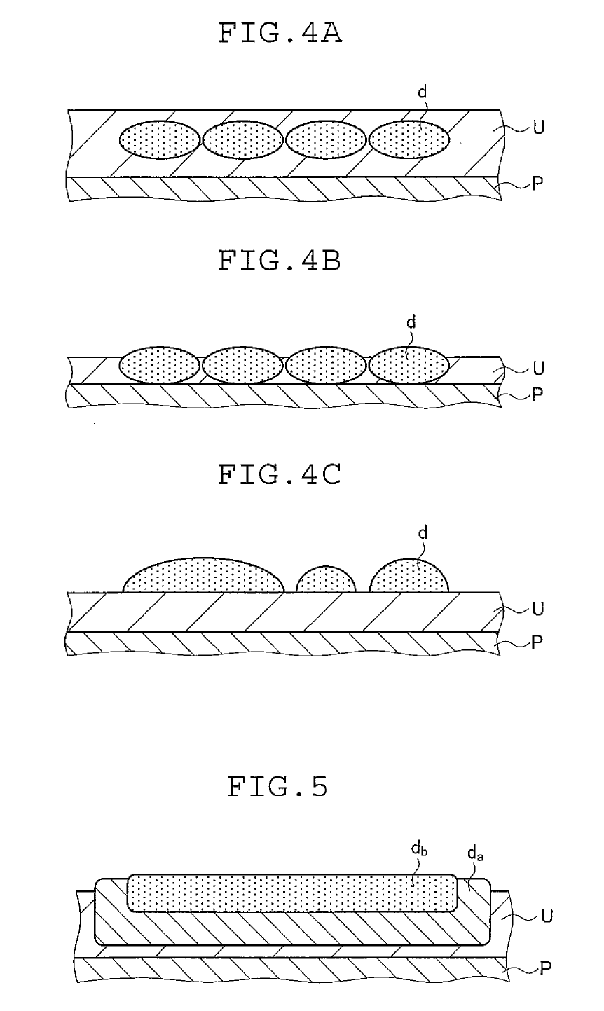

FIG. 3 is a schematic sectional view of a recording medium where ink droplets have been deposited onto a semi-cured undercoating liquid. FIGS. 4A and 4B are schematic sectional views of recording media where ink droplets have been deposited onto an undercoating liquid that is in an uncured state, and FIG. 4C is a schematic sectional view of a recording medium where ink droplets have been deposited onto an undercoating liquid that is in a completely cured state.

When the undercoating liquid is semi-cured according to the invention, the degree of cure on the recording medium P side is higher than the degree of cure at the surface layer. In this case, three features are observable. That is, as shown in FIG. 3, when ink d is deposited as droplets on a semi-cured undercoating liquid U, (1) a portion of the ink d emerges at the surface of the undercoating liquid U, (2) a portion of the ink d lies within the undercoating liquid U, and (3) the undercoating liquid is present between the bottom side of the ink d and the recording medium P.

When the ink d is deposited on the undercoating liquid U, if the undercoating liquid U and the ink d satisfy the above states (1), (2) and (3), the undercoating liquid U can be regarded as being in a semi-cured state.

By semi-curing the undercoating liquid U, that is, by curing the undercoating liquid U so that it satisfies above (1), (2) and (3), the droplets of ink d (i.e., the ink droplets) which have been deposited to a high density mutually connect, forming a film of the ink d (i.e., an ink film or ink layer), and thus providing a uniform and high color density.

By contrast, when the ink is deposited on the undercoating liquid which is in an uncured state, either or both of the following occur: all of the ink d lies within the undercoating liquid U as shown in FIG. 4A; a state arises where, as shown in FIG. 4B, the undercoating liquid U is not present below the ink d.

In this case, even when the ink is applied to a high density, the liquid droplets are mutually independent, causing the color density to decrease.

When the ink is deposited on an undercoating liquid that is completely cured, as shown in FIG. 4C, a state will arise where the ink d does not lie within the undercoating liquid U.

In this case, interference in the deposition of the droplets arises, as a result of which a uniform ink film cannot be formed and a high color reproducibility cannot be achieved (i.e., this leads to a decrease in color reproducibility).

Here, when the droplets of ink are applied to a high density, the droplets are not independent of each other. To form a uniform ink film, and also to suppress the occurrence of deposition interference, the quantity of regions where the undercoating liquid (i.e., the undercoat) is uncured per unit surface area is preferably smaller, and more preferably substantially smaller, than the maximum quantity of droplets of ink applied per unit surface area. That is, the relationship between the weight Mᵤ (also referred to as M_{undercoating liquid}) of uncured regions of the undercoat per unit surface area and the maximum weight mᵢ (also referred to as mᵢₙₖ) of the ink ejected per unit surface area preferably satisfies the condition (mᵢ/30)<Mᵤ<mᵢ, more preferably satisfies the condition (mᵢ/20)<Mᵤ<(mᵢ/3), and most preferably satisfies the condition (mᵢ/10)<Mᵤ<(mᵢ/5). As used herein, the “maximum weight of the ink ejected per unit surface area” refers to the maximum weight per color.

By letting (mᵢ/30)<Mᵤ, deposition interference can be prevented from occurring. Moreover, a high dot size reproducibility can be achieved. By letting Mᵤ<mᵢ, the ink film can be uniformly formed and a decrease in density can be prevented.

Here, the weight of uncured regions of the undercoating liquid per unit surface area is determined by a transfer test. Specifically, after completion of the semi-curing step (e.g., after exposure to active energy rays) and before deposition of the ink droplets, a permeable medium such as plain paper is pressed against the undercoating liquid which is in a semi-cured state, and the amount of the undercoating liquid that transfers to the permeable medium is determined by weight measurement. The measured value is defined as the weight of the uncured regions of the undercoating liquid.

For example, if the maximum amount of ink ejected is set to 12 picoliters per pixel at a deposition density of 600×600 dpi, the maximum weight mᵢ of the ink ejected per unit surface area becomes 0.04 g/cm² (assuming the density of the ink is about 1.1 g/cm³). Therefore, in this case, the weight Mᵤ per unit surface area of uncured regions of the undercoating liquid is preferably greater than 0.0013 g/cm² but less than 0.04 g/cm², more preferably greater than 0.002 g/cm² but less than 0.013 g/cm², and most preferably greater than 0.004 g/cm² but less than 0.008 g/cm².

In the practice of the invention, as in the case of the undercoating liquid, “semi-curing the ink” signifies partial curing, and refers to a state where the liquid ink (i.e., ink, colored liquid) is in a partially cured, but not a completely cured, state. When the ink liquid ejected onto the undercoating liquid is semi-cured, the degree of cure may be non-uniform; preferably, the degree of cure proceeds in the depth direction of the ink liquid. In the present embodiment, the ink that is to be semi-cured is in the form of ink droplets which land on the undercoat or recording medium and form an ink layer.

When this ink is semi-cured and an ink of a different hue is deposited on top of the semi-cured ink, there can be achieved a technical effect which is advantageous to the quality of the resulting print. The mechanism of action may be confirmed by examining a cross-section of the print.

Semi-curing of the ink (i.e., the ink droplets which have landed on the recording medium or the undercoat, or the ink layer formed from ink droplets which have landed) is explained below.

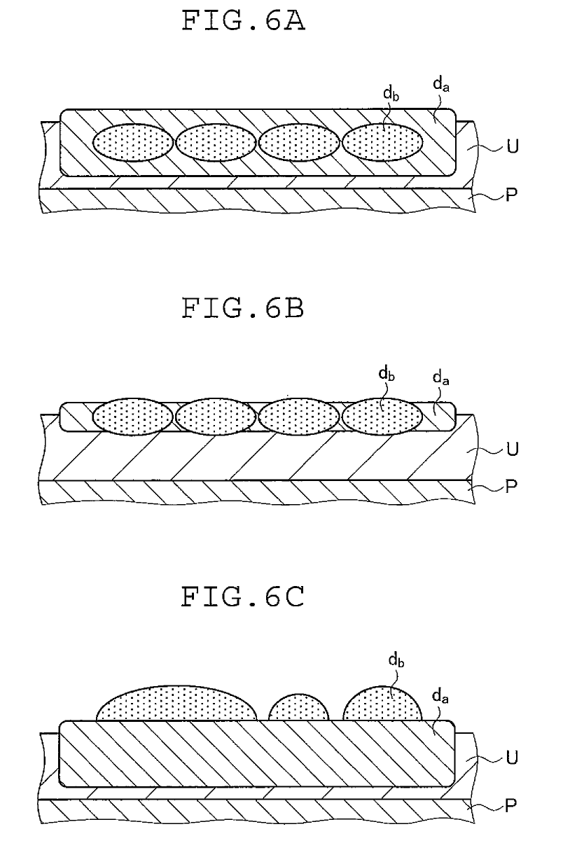

FIG. 5 is a schematic sectional view of a recording medium where a second ink d_{b} has been deposited onto a semi-cured first ink dₐ. FIGS. 6A and 6B are schematic sectional views of recording media where droplets of the second ink d_{b} have been deposited onto the first ink dₐ that is in an uncured state, and FIG. 6C is a schematic sectional view of a recording medium where droplets of the second ink d_{b} have been deposited onto the first ink dₐ that is in a completely cured state.

When a secondary color is formed by depositing droplets of the second ink d_{b} onto the first ink dₐ that has been earlier deposited as droplets, it is preferable to apply the second ink d_{b} onto the first ink dₐ with the latter in a semi-cured state.

Here, the “semi-cured state” of the first ink dₐ is similar to the above-described semi-cured state of the undercoating liquid. As shown in FIG. 5, this is a state where, when the second ink d_{b} is deposited as droplets onto the first ink dₐ, (1) a portion of the second ink d_{b} emerges at the surface of the first ink dₐ, (2) a portion of the second ink d_{b} lies within the first ink dₐ, and (3) the first ink dₐ is present below the second ink d_{b}.

By semi-curing the ink in this way, a cured film (colored film A) of the first ink dₐ and a cured film (colored film B) of the second ink d_{b} can be suitably superimposed, enabling good color reproduction to be achieved.

By contrast, when the second ink d_{b} is deposited as droplets on the first ink dₐ with the latter in an uncured state, either or both of the following occur: all of the second ink d_{b} lies within the first ink dₐ as shown in FIG. 6A; a state arises where, as shown in FIG. 6B, the first ink dₐ is not present below the second ink d_{b}. In this case, even when the second ink d_{b} is applied to a high density, the droplets are independent of each other, causing the color saturation of the secondary color to decrease.

When the second ink d_{b} is deposited as droplets on the first ink dₐ which is completely cured, as shown in FIG. 6C, a state will arise where the second ink d_{b} does not lie within the first ink dₐ. This causes interference in the deposition of the droplets to arise, as a result of which a uniform ink film cannot be formed, leading to a decline in color reproducibility.

Here, when the droplets of the second ink d_{b} are applied to a high density, the droplets are not independent of each other. To form a uniform film of the second ink d_{b}, and also to suppress the occurrence of deposition interference, the quantity of regions where the first ink dₐ is uncured per unit surface area is preferably smaller, and more preferably substantially smaller, than the maximum quantity of droplets of the second ink d_{b} applied thereon per unit surface area. That is, the relationship between the weight M_{da} (also referred to as M_{ink A}) of uncured regions of the first ink dₐ layer per unit surface area and the maximum weight m_{db} (also referred to as m_{ink B}) of the second ink d_{b} ejected thereon per unit surface area preferably satisfies the condition (m_{db}/30)<M_{da}<m_{db}, more preferably satisfies the condition (m_{db}/20)<M_{da}<(M_{db}/3), and most preferably satisfies the condition (m_{db}/10)<M_{da}<(m_{db}/5).

By letting (m_{db}/30)<M_{da}, deposition interference can be prevented from occurring. Moreover, a high dot size reproducibility can be achieved. By letting M_{da}<m_{db}, a film of the first ink dₐ can be uniformly formed and a decrease in density can be prevented.

Here, as in the case of the undercoating liquid described above, the weight of the uncured regions of the first ink dₐ per unit surface area is determined by a transfer test. Specifically, after completion of the semi-curing step (e.g., after exposure to active energy rays) and before deposition of the droplets of the second ink d_{b}, a permeable medium such as plain paper is pressed against the layer of the first ink dₐ which is in a semi-cured state, and the quantity of the first ink dₐ that transfers to the permeable medium is determined by weight measurement. The measured value is defined as the weight of the uncured regions of the ink liquid.

For example, if the maximum amount of the second ink d_{b} ejected is set to 12 picoliters per pixel at a deposition density of 600×600 dpi, the maximum weight m_{db} of the second ink d_{b} ejected per unit surface area becomes 0.04 g/cm² (assuming the density of the second ink d_{b} to be about 1.1 g/cm³). Therefore, in this case, the weight M_{da} per unit surface area of uncured regions of the first ink dₐ layer is preferably greater than 0.0013 g/cm² but less than 0.04 g/cm², more preferably greater than 0.002 g/cm² but less than 0.013 g/cm², and most preferably greater than 0.004 g/cm² but less than 0.008 g/cm².

When the semi-cured state of the undercoating liquid and/or the ink is realized by a polymerization reaction of a polymerizable compound that is initiated by the irradiation of active energy rays or heating, to enhance the scuff resistance of the print, the unpolymerization ratio (i.e., A_{after polymerization}/A_{before polymerization}) is preferably at least 0.2 but not more than 0.9, more preferably at least 0.3 but not more than 0.9, and most preferably at least 0.5 but not more than 0.9.

Here, A_{before polymerization} is the infrared absorption peak absorbance attributable to polymerizable groups before the polymerization reaction, and A_{after polymerization} is the infrared absorption peak absorbance attributable to polymerizable groups after the polymerization reaction.

For example, when the polymerizable compound included in the undercoating liquid and/or the ink is an acrylate monomer or a methacrylate monomer, absorption peaks based on polymerizable groups (acrylate groups, methacrylate groups) can be observed near 810 cm⁻¹. Accordingly, the above unpolymerization ratio is preferably defined in terms of the absorbances of these peaks. When the polymerizable compound is an oxetane compound, an absorption peak based on polymerizable groups (oxetane rings) can be observed near 986 cm⁻¹. The above unpolymerization ratio is thus preferably defined in terms of the absorbance of this peak. When the polymerizable compound is an epoxy compound, an absorption peak based on the polymerizable groups (epoxy groups) can be observed near 750 cm⁻¹. Hence, the above unpolymerization ratio is preferably defined in terms of the absorbance of this peak.

A commercial infrared spectrophotometer may be used as the means for measuring the infrared absorption spectrum. The spectrophotometer may be either a transmission-type or reflection-type system. Suitable selection according to the form of the sample is preferred. Measurement may be carried out using, for example, an FTS-6000 infrared spectrophotometer manufactured by Bio-Rad.

In the case of a curing reaction based on an ethylenically unsaturated compound or a cyclic ether, the unpolymerization ratio may be quantitatively measured from the percent conversion of ethylenically unsaturated groups or cyclic ether groups.

The method used to semi-cure the undercoating liquid and/or the ink is exemplified by known thickening methods, e.g., (1) methods that use an agglomerating effect, such as by furnishing a basic compound to an acidic polymer or by furnishing an acidic compound and a metal compound to a basic polymer; (2) methods wherein the undercoating liquid and/or the ink is prepared beforehand at a high viscosity, then the viscosity is lowered by adding thereto a low-boiling organic solvent, after which the low-boiling organic solvent is evaporated so as to return the liquid to its original high viscosity; (3) methods in which the undercoating liquid and/or the ink prepared at a high viscosity is first heated, then is cooled so as to return the liquid to its original high viscosity; and (4) methods in which the undercoating liquid and/or the ink is semi-cured through a curing reaction induced by exposing the undercoating liquid and/or the ink to active energy rays or heat. Of these, (4) methods in which the undercoating liquid and/or the ink is semi-cured through a curing reaction induced by exposing the undercoating liquid and/or the ink to active energy rays or heat are preferred.

“Methods in which the undercoating liquid and/or the ink is semi-cured through a curing reaction induced by exposing the undercoating liquid and/or the ink to active energy rays or heat” refers herein to methods in which the polymerization reaction on polymerizable compounds at the surface of the undercoating liquid and/or the ink furnished to the recording medium is carried out incompletely. At the surface of the undercoating liquid and/or the ink, compared with the interior thereof, the polymerization reaction tends to be inhibited by the influence of oxygen present in air. Therefore, by controlling the conditions of exposure to active energy rays or heat, it is possible to trigger the reaction for semi-curing the undercoating liquid and/or the ink.

The amount of energy required to semi-cure the undercoating liquid and/or the ink varies with the type and content of polymerization initiator. When the energy is applied by active energy rays, an amount of about 1 to about 500 mJ/cm² is generally preferred. When the energy is applied as heat, from 0.1 to 1 second of heating under temperature conditions where the surface temperature of the recording medium falls within a temperature range of 40 to 80° C. is preferred.

The application of active energy rays or heat, such as with active rays or heating, promotes the generation of active species by decomposition of the polymerization initiator. At the same time, the increase in active species or the rise in temperature promotes the curing reaction through polymerization or crosslinking of polymerizable or crosslinkable materials induced by the active species.

A thickening (rise in thickness) may also be suitably carried out by exposure to active rays or by heating.

The ink-jet recording device of the invention is described below in further detail by referring to the operation of the ink-jet recording device 10, that is, its recording action on the recording medium P.

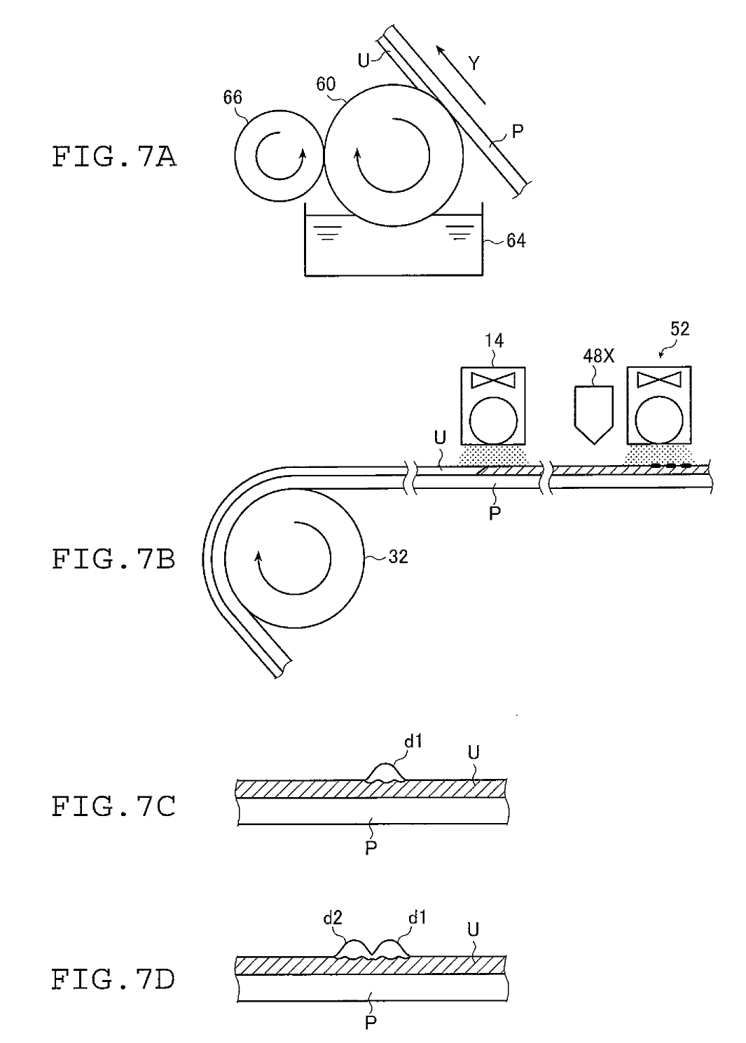

FIGS. 7A to 7D are views schematically showing steps of forming an image on a recording medium, respectively.

The recording medium P having been let out from the feed roll 30 is transported in a specified direction (direction “Y” in FIG. 1) by rotation of the transport roll 32 and the transport roller pair 34. As described above, the recording medium P in this embodiment is a web with a certain length or more and is transported without being cut.

As shown in FIG. 7A, the recording medium P having been let out from the feed roll 30 comes into contact with the coating roll 60 of the undercoat forming section 13 and the undercoating liquid is applied onto the surface thereof to form an undercoat U. The drive unit 62 causes the coating roll 60 to rotate in the direction opposite to the direction of travel of the recording medium P.

The recording medium P on which the undercoat U has been formed by application of the undercoating liquid is further transported by the transport roll 32 and the transport roller pair 34 of the transport section 12 and passes through the position facing the undercoating liquid semi-curing section 14.

As shown in FIG. 7B, the undercoating liquid semi-curing section 14 irradiates with ultraviolet light, the recording medium P onto which the undercoating liquid has been applied and which is passing through the position facing the section 14, thereby semi-curing the undercoat U on the recording medium P.

The recording medium P having thereon the semi-cured undercoating liquid is further transported by the transport roll 32 and the transport roller pair 34 of the transport section 12 and passes through the position facing the recording head 48X.

The recording head 48X ejects ink droplets from its ejection orifices to form an image on the recording medium P which is being transported by the transport section 12 and passing through the position opposed thereto.

More specifically, the recording head 48X ejects a first ink droplet d1 onto the recording medium P. As shown in FIG. 7C, the first ink droplet d1 ejected from the recording head 48X is deposited onto the surface of the undercoat U. The undercoat U is in a semi-cured state and has an uncured surface, and is therefore receptive to the ink droplet d1.

As shown in FIG. 7D, the recording head 48X ejects a second ink droplet d2 in proximity to the position where the previously ejected first ink droplet d1 was deposited. In this case, the undercoat U is also in a semi-cured state and has an uncured surface, and is therefore receptive to the ink droplet d2.

In the case where the ink droplets d1 and d2 have been deposited in proximity to each other on the recording medium P, a force acts to make the ink droplets d1 and d2 coalesce, but interference between the ink droplets having been deposited onto the recording medium P is suppressed by the resistance force of the undercoat U against coalescence of the ink droplets because the undercoat U is semi-cured and has an increased viscosity.

Ink droplets are thus ejected from the recording head 48X in accordance with the control by the control unit 20 and deposited onto the recording medium P to form an image.

The recording medium P having the image formed by the recording head 48X is further transported by the transport section 12 and passes through the position facing the UV irradiation unit 52X disposed downstream from the recording head 48X.

The UV irradiation unit 52X irradiates the recording medium P passing through the position opposed thereto with ultraviolet light to semi-cure the image formed by the recording head 48X on the recording medium P, that is, semi-cure the ink droplets having been deposited onto the recording medium P.

Thereafter, the recording medium P is further transported and passes in order through the positions facing the recording head 48Y, the UV irradiation unit 52Y, the recording head 48C, the UV irradiation unit 52C, the recording head 48M, the UV irradiation unit 52M, and the recording head 48K, respectively. As in the case where the recording medium P passed through the positions facing the recording head 48X and its corresponding UV irradiation unit 52X, formation of an image and semi-curing of the formed image are performed each time the recording medium P passes through the positions facing the recording head of each color and its corresponding UV irradiation unit.

After an image has been formed by the recording head 48K, the recording medium P passes through the position facing the final UV irradiation unit for curing 54.

The final UV irradiation unit for curing 54 irradiates the recording medium P with more intense ultraviolet light than the other UV irradiation units to cure the whole of the images on the recording medium P formed by the various recording heads including the image recorded by the recording head 48K as well as the undercoating liquid.

A color image is thus formed on the recording medium P.

The recording medium P having the color image formed thereon is further transported by the transport roll 32 and the transport roller pair 34 to be taken up onto the recovery roll 36.

The ink-jet recording device 10 thus forms the image on the recording medium P.

In the ink-jet recording device 10, the fluorescent lamps 80 of the UV irradiation units 52X, 52Y, 52C and 52M each have the reflective film 90 and the phosphor film 92 stacked on top of each other inside the bulb 86 with the apertures 94, 96 formed on the recording medium P side, and the apertures 94, 96 have such shapes that the aperture angles α and β satisfy the conditions: β<α, 60°≦α≦150° and 30°≦β≦90°. Higher intensity light can be emitted toward the side of the recording medium P, which ensures semi-curing or curing of the undercoating liquid and/or ink on the recording medium P in a short time, whereby the recording medium P can be transported at a higher speed to achieve higher productivity.

Since high intensity light can be selectively emitted toward the side of the recording medium P, occurrence of nozzle clogging that may be caused by curing of ink in the ink droplet-ejecting nozzles of the recording heads under the influence of light the recording heads received from the adjacent fluorescent lamp 80 can be prevented or reduced. In other words, stray light on the recording heads can be reduced or eliminated to prevent or reduce clogging of the ink-jet nozzles, whereby cleaning or replacement of the recording heads is not required or is reduced to achieve higher maintainability, thus enabling images to be consistently formed for a long period of time.

Even in the case of an inexpensive fluorescent lamp which is low in emission intensity with respect to the whole periphery of the lamp, the recording medium P can be irradiated with high intensity light in a substantially uniform manner by providing a reflective film and setting the aperture angles of the apertures for the reflective film and the phosphor film in the above-defined ranges.

Light from the fluorescent lamp can be thus used efficiently. Therefore, an inexpensive fluorescent lamp can be employed to manufacture the ink-jet recording device at a low cost. In addition, fluorescent lamps use less power than metal halide lamps, high-pressure mercury vapor lamps and other active energy ray-irradiating devices, whereby power consumption of the ink-jet recording device can be reduced.

Moreover, high intensity light can be selectively emitted toward the recording medium P side with the use of a fluorescent lamp, which enables the light intensity and irradiation area to be adjusted without relying on precise reflection design using reflective members or other members.

Particularly in the case of semi-curing ink on the recording medium P as in the embodiment under consideration, a considerably large amount of irradiation excessively or completely cures the ink, whereas a small amount of irradiation renders the ink uncured. However, according to the present invention that is capable of controlling the amount of irradiation more easily, ink can be reliably semi-cured to a desired level to record a high-resolution image.

By providing the reflective film inside the bulb of the fluorescent lamp (more specifically on the inner wall surface of the bulb), high intensity light can be emitted toward the side of the recording medium P without disposing a reflector or other reflective member on the circumference of the fluorescent lamp, which avoids the necessity of leaving space for disposing a reflective member such as a reflector on the circumference of the fluorescent lamp, thus enabling the UV irradiation units and the image fixing section and hence the ink-jet recording device to be downsized.

The fluorescent lamp 80 does not emit high intensity light to the areas other than the recording medium P. The housing 82 having the opening formed on the recording medium P side is disposed so as to surround the fluorescent lamp 80, which further ensures that light emitted from the fluorescent lamp 80 reaches the recording medium P while it is prevented from being irradiated onto the other areas than the recording medium P.

The cooling mechanism 84 serves to maintain the fluorescent lamp 80 at a constant temperature, so that the amount of light emitted from the fluorescent lamp 80 is prevented from varying with the temperature and can be made constant. Ink and/or undercoating liquid can be thus consistently semi-cured or cured with a constant amount of light.

The cooling mechanism 84 preferably adjusts the surface temperature of the fluorescent lamp 80 and more specifically the temperature of its surface away from the recording medium P in the range of from 30° C. to 60° C. and also the temperature variations within 5° C. The amount of light emitted from the fluorescent lamp 80 can be made constant while offering high power by maintaining the temperature within the above-defined range.

By thus forming the undercoat on the recording medium P, the ink droplets having been deposited onto the recording medium can be prevented from permeating the recording medium to cause image bleed, thus enabling a high-resolution image to be formed. It also becomes possible to use a recording medium which has a low adhesion to ink droplets, namely, may repel ink droplets having been deposited thereonto. In other words, image recording on various recording media becomes possible. By using the coating roll 60 and, moreover, by rotating the coating roll 60 in a direction opposite to the direction of travel of the recording medium P to coat undercoating liquid onto the recording medium P, disruption of the surface of the undercoating liquid on the recording medium P when the coating roll 60 separates from the recording medium P after having applied undercoating liquid to the recording medium P can be prevented, enabling the undercoat U having an improved surface state to be formed on the recording medium P.

By semi-curing the undercoat in the undercoating liquid semi-curing section as in the present embodiment, even when ink droplets having portions which mutually overlap are deposited on the recording medium, the coalescence of these neighboring ink droplets can be suppressed through interactions between the undercoating liquid and the ink droplets.

That is, by forming a semi-cured undercoat on the recording medium, the migration of ink droplets can be prevented in cases where ink droplets ejected from the recording heads are deposited in close proximity on the recording medium, such as when ink droplets of a single color having portions which mutually overlap are deposited on a recording medium or even when ink droplets of different colors having portions which mutually overlap are deposited on a recording medium.

In this way, image bleed, line width non-uniformities such as of fine lines in the image, and color unevenness on colored surfaces can be effectively prevented from occurring, enabling the formation of uniform-width, sharp line shapes, and thus making it possible to carry out the recording of ink-jet images of a high deposition density, such as reversed letters, with good reproducibility of fine features such as fine lines. That is, higher-resolution images can be formed on the recording medium.

By placing a UV irradiation unit between the adjacent recording heads and semi-curing the ink droplets deposited onto (i.e., the image formed on) the recording medium using the respective recording heads, it is possible to prevent different-color ink droplets deposited at adjacent positions from overlapping and to keep the deposited ink droplets from migrating.

On the travel path of the recording medium, the UV irradiation unit corresponding to the recording head disposed on the furthest downstream side serves as the final UV irradiation unit for curing and, because it emits higher intensity UV light than the other UV irradiation units, has the ability to reliably cure images that have been formed on the recording medium.

In view of further device downsizing, energy saving and cost reduction, the final UV irradiation unit for curing 54 is configured in the same manner as the UV irradiation units 52X, 52Y, 52C and 52M in the embodiment under consideration. However, use may also be made of various UV light sources such as metal halide lamps and high-pressure mercury vapor lamps for the final UV irradiation unit for curing 54.

It is also preferable to use metal halide lamps and high-pressure mercury vapor lamps for the final UV irradiation unit for curing 54. In other words, the ink-jet recording device is preferably configured so that the UV irradiation units each including the fluorescent lamp 80 are used for semi-curing the undercoating liquid and/or ink, whereas a metal halide lamp, high-pressure mercury vapor lamp or other lamp is used for the final UV irradiation unit for curing 54.

Use of a metal halide lamp, high-pressure mercury vapor lamp or other lamp for the final UV irradiation unit for curing 54 leads to device upsizing but enables higher intensity light to be irradiated onto the undercoating liquid and ink on the recording medium, thus achieving complete curing of the undercoating liquid and ink more reliably.

In view of prevention of clogging of the recording head nozzles, production of prints at a high rate, appropriate semi-curing as well as further device downsizing, energy saving and cost reduction, it is preferable for the fluorescent lamp 80 to be provided in every UV irradiation unit for semi-curing the undercoating liquid and/or ink. However, this is not the sole case of the present invention. The ink-jet recording device may also be configured so that at least one of the UV irradiation units includes the fluorescent lamp 80 and the other UV irradiation units each include a metal halide lamp, a high-pressure mercury vapor lamp, a fluorescent lamp having a reflective film and/or a phosphor film which does not satisfy the above-defined range, or a fluorescent lamp having no reflective film.

The fluorescent lamp 80 is preferably disposed at such a position that the shortest distance h (mm) between the irradiation surface of the fluorescent lamp 80 and the recording medium P is in the range of from 0.5 mm to 1.5 mm. The recording medium P can be irradiated with light with high efficiency by disposing the fluorescent lamp 80 at the position where the above-defined range is satisfied.

In a preferred embodiment, in the case where h is equal to or larger than 0.5 mm but is smaller than 1.0 mm (0.5≦h<1.0), the housing 82 is disposed at such a position that the shortest distance H (mm) between the housing 82 and the recording medium P is equal to h (H=h), whereas in the case where h is equal to or larger than 1.0 mm (1.0≦h), the housing is disposed at such a position that H is equal to 1.0 mm (H=1.0).

The amount of light irradiated onto other portions than the recording medium P after having been emitted from the fluorescent lamp 80 can be reduced by disposing the housing 82 at a position satisfying the above-defined range.

It is preferred to irradiate the recording medium with UV light in a period of several hundred milliseconds to 5 seconds after the ink droplets from the recording head have been deposited on the recording medium to thereby semi-cure the ink droplets deposited thereon.

By thus semi-curing the ink droplets in the period of several hundred milliseconds to 5 seconds after their deposition, the ink droplets on the recording medium can be prevented from getting out of shape, enabling a high-resolution image to be formed.

The undercoating liquid has a viscosity of preferably at least 10 mPa·s but not more than 500 mPa·s, and more preferably at least 50 mPa·s but not more than 300 mPa·s.

At an undercoating liquid viscosity of at least 10 mPa·s, and more preferably at least 50 mPa·s, as noted above, it is possible to coat the undercoating liquid onto even a recording medium to which liquid does not readily adhere.

At an undercoating liquid viscosity of not more than 500 mPa·s, and more preferably not more than 300 mPa·s, it is possible to more reliably achieve a lower surface roughness in the undercoat that is formed on the recording medium P.

The ink-jet recording device 10 is described below in further detail with reference to specific examples.

In the example to be described below, measurement was made for the print productivity and the state of clogging of the recording head nozzles by setting the aperture angle α of the aperture 94 for the reflective film 90 of the fluorescent lamp 80 and the aperture angle β of the aperture 96 for the phosphor film 92 of the fluorescent lamp 80 to various values.

A linear tube with a diameter of 32 mm was used for the bulb and a phosphor emitting light at a central wavelength of 365 nm was used for the phosphor film in the fluorescent lamp 80.

The fluorescent lamp 80 was disposed at such a position that the shortest distance h between the irradiation surface of the fluorescent lamp and the recording medium P was 1 mm, whereas the housing 82 was disposed at such a position that the shortest distance H between the housing 82 and the recording medium P was 1 mm. The ink-jet head used was one having a resolution of 600 dpi.

Measurement was made under the above-described conditions using fluorescent lamps each of which included the reflective film 90 whose aperture 94 had an aperture angle α of 210°, 180°, 170°, 150°, 120°, 91°, 60°, or 30° while also changing the aperture 96 in the phosphor film 92 so as to have an aperture angle β of 180°, 120°, 90°, 60°, or 30° in the above respective cases.

Measurement was made for the productivity according to the method described below.

About 12 pl of ink droplets were ejected from the recording head onto the semi-cured undercoat with a thickness of 5 μm formed on the recording medium P at a density of 600×600 dpi to thereby form a so-called solid image. Then, UV light was irradiated onto the solid image from the UV irradiation unit having the fluorescent lamp satisfying the respective conditions described above. Whether or not the deposited ink droplets had been semi-cured following passage of the recording medium under the UV irradiation unit was checked.

Whether or not the ink droplets had been semi-cured was checked for the recording media P transported at various transport speeds. Of the transport speeds at which the ink droplets were found to be semi-cured, the fastest transport speed was regarded as the speed appropriate for the productivity.

Next, recording operation was continuously made for 1 hour, then the recording head was wiped off. Thereafter, whether or not the recording head nozzles were clogged was checked from the state of ejection from the recording head nozzles. More specifically, the recording head following wiping off was rated “excellent” when the state of non-ejection was not found in any nozzle, “good” when some of the nozzles were in the state of non-ejection but could be recovered with a simple maintenance operation, “fair” when some of the nozzles were in the state of non-ejection but could be recovered with a usual maintenance operation, and “poor” when some of the nozzles were in the state of non-ejection and could not be recovered thus requiring replacement with a new recording head.

The evaluation results are shown in Table 1 below.

TABLE 1

| Aperture angle | Aperture | Productivity | | |
|---|---|---|---|---|
| α in reflective | angle β in | (high-speed | Nozzle | Evalu- |
| film | phosphor film | performance) | clogging | ation |
| 210 ° | 180° | 100 mm/s | Poor | Poor |
| | 120° | 200 mm/s | Poor | Poor |
| | 90° | 300 mm/s | Poor | Poor |
| | 60° | 400 mm/s | Poor | Poor |
| | 30° | 300 mm/s | Poor | Poor |
| 180° | 180° | 100 mm/s | Poor | Poor |
| | 120° | 200 mm/s | Poor | Poor |
| | 90° | 300 mm/s | Poor | Poor |
| | 50° | 400 mm/s | Poor | Poor |
| | 30° | 300 mm/s | Poor | Poor |
| 170° | 180° | 100 mm/s | Poor | Poor |
| | 120° | 200 mm/s | Poor | Poor |
| | 90° | 300 mm/s | Poor | Poor |
| | 60° | 400 mm/s | Poor | Poor |
| | 30° | 300 mm/s | Poor | Poor |
| 150° | 180° | 100 mm/s | Fair | Poor |
| | 120° | 200 mm/s | Fair | Poor |
| | 90° | 400 mm/s | Eair | Fair |
| | 60° | 600 mm/s | Fair | Fair |
| | 30° | 400 mm/s | Fair | Fair |
| 120° | 180° | 100 mm/s | Good | Poor |
| | 120° | 200 mm/s | Good | Poor |
| | 90° | 400 mm/s | Good | Good |
| | 60° | 600 mm/s | Good | Good |
| | 30° | 400 mm/s | Good | Good |
| 90° | 180° | 100 mm/s | Good | Poor |
| | 120° | 200 mm/s | Good | Poor |
| | 90° | 300 mm/s | Good | Poor |
| | 60° | 600 mm/s | Good | Good |
| | 30° | 400 mm/s | Good | Good |
| 60° | 180° | 100 mm/s | Excellent | Poor |
| | 120° | 200 mm/s | Excellent | Poor |
| | 90° | 200 mm/s | Excellent | Poor |
| | 60° | 300 mm/s | Excellent | Poor |
| | 30° | 400 mm/s | Excellent | Excellent |
| 30° | 180° | 50 mm/s | Excellent | Poor |
| | 120° | 50 mm/s | Excellent | Poor |
| | 90° | 100 mm/s | Excellent | Poor |
| | 60° | 200 mm/s | Excellent | Poor |
| | 30° | 200 mm/s | Excellent | Poor |

Table 1 shows that nozzle clogging can be suppressed by adjusting the aperture angle α of the aperture for the reflective film to not more than 150°; can be further suppressed at an aperture angle α of not more than 120°, enabling the nozzles to be recovered with a simple maintenance operation; and can be prevented at an aperture angle α of not more than 60°.

It is also seen that, by setting the aperture angle α of the aperture for the reflective film and the aperture angle β of the aperture for the phosphor film so as to satisfy the conditions: β<α, 60°≦α≦150° and 30°≦β≦90°, ink droplets can be semi-cured even at a recording medium P transport speed of 400 mm/s while also suppressing nozzle clogging, whereby high-resolution images can be consistently and rapidly produced for a long period of time.

The above results clearly show the beneficial effects of the present invention.

The reflective film of the fluorescent lamp 80 preferably has a transmittance of not more than 10%.

At a reflective film transmittance of not more than 10%, light is more reliably prevented from being emitted from the other areas than the apertures, whereby the recording medium P can be irradiated with higher intensity light to achieve further improved productivity. UV light is also more reliably prevented from reaching the recording heads.

The various effects as described above can be achieved by providing the fluorescent lamp with such a shape that the aperture angle α of the aperture for the reflective film and the aperture angle β of the aperture for the phosphor film satisfy β<α, 60°≦α≦150° and 30°≦β≦90°. However, irrespective of the aperture shapes in the phosphor film and the reflective film, curing in a shorter period of time is possible by setting the transmittance of the reflective film in the fluorescent lamp to not more than 10%. The transport speed of the recording medium and hence the productivity can be improved.

A further detailed description is given below with reference to another specific example.

An ink-jet recording device of the same structure as in the first example was used in this example, and the print productivity was measured using four fluorescent lamps in which the reflective films had transmittance values of 30%, 20%, 10% and 5%, respectively. In this example, the aperture in the reflective film had an aperture angle of 90°, whereas the aperture in the phosphor film had an aperture angle of 60°.

The measurement results are shown in Table 2 below.

TABLE 2

| Transmittance of reflective | Productivity (high-speed |
|---|---|
| film | performance) |
| 30% | 50 mm/s |
| 20% | 100 mm/s |
| 10% | 400 mm/s |
| 5% | 600 mm/s |

As is seen from Table 2, the productivity can be drastically improved by setting the reflective film transmittance to not more than 10%. It is clear that a similar tendency is seen even if the aperture angle is changed.

The above results clearly show the beneficial effects of the present invention.

As in the above-described embodiment, the aperture for the reflective film and that for the phosphor film in the fluorescent lamp preferably have shapes which are symmetric with respect to the axial plane connecting the center of the fluorescent lamp (i.e., axis of the tubular member) with the recording medium.

By thus forming the apertures for the reflective film and the phosphor film so as to have symmetric shapes with respect to the axial plane connecting the center of the fluorescent lamp with the recording medium, light emitted from the fluorescent lamp can be irradiated onto the recording medium which is at the shortest distance from the fluorescent lamp, while also reducing the area where light emitted from the fluorescent lamp is irradiated. In this way, the recording medium can be irradiated with higher intensity light. In addition, light is more reliably prevented from reaching the adjacent recording heads to cause their nozzles to be clogged.

A getter is preferably sealed within the fluorescent lamp.

The getter included therein can prolong the service life of the fluorescent lamp. In other words, the intensity of light emitted from the fluorescent lamp can be maintained for a long time to enable the replacement frequency and the running costs to be reduced.

Use of a zirconium alloy for the getter enables the getter to initiate a gas adsorption reaction more easily.

In the above-described embodiment, the cooling mechanism is provided in the housing, but the present invention is not limited to this as long as the fluorescent lamp can be cooled. In the case of a structure in which the UV irradiation unit has no housing, a cooling mechanism may be separately disposed.

It is preferable to provide a cooling mechanism that cools the fluorescent lamp and keeps the temperature of the fluorescent lamp constant, because light can be more consistently emitted from the fluorescent lamp. However, this is not the sole case of the present invention and the fluorescent lamp may not be provided with a cooling mechanism.

In the present embodiment, by disposing UV irradiation units between recording heads of the respective ink colors and curing the image areas on the recording medium each time an image is recorded at each of the respective recording heads, as noted above, it is possible to prevent ink of different colors from intermingling, thus enabling higher resolution images to be formed. Accordingly, a UV irradiation unit was positioned at each of the recording heads. However, the present invention is not limited in this regard. To illustrate, in an alternative arrangement, a single UV irradiation unit may be disposed for a plurality of recording heads.

In the present embodiment, the recording head unit has recording heads of a total of five colors consisting of a special color (X) and yellow (Y), cyan (C), magenta (M) and black (K). However, it is also possible to employ a recording head unit having other combinations of heads, including a recording head unit having heads for only the four colors YCMK, or a recording head unit having heads for six or more colors, including another special color head. The recording heads of the respective colors may be disposed in any order without any particular limitation.

Nor is the invention limited to requiring the disposition of a plurality of recording heads. That is, the ink-jet recording device of the invention may be one which uses a single recording head to form an image on the recording medium, then irradiates the image with UV light to form a single-color image.

The digital label printer using the ink-jet recording device of the invention is described below.

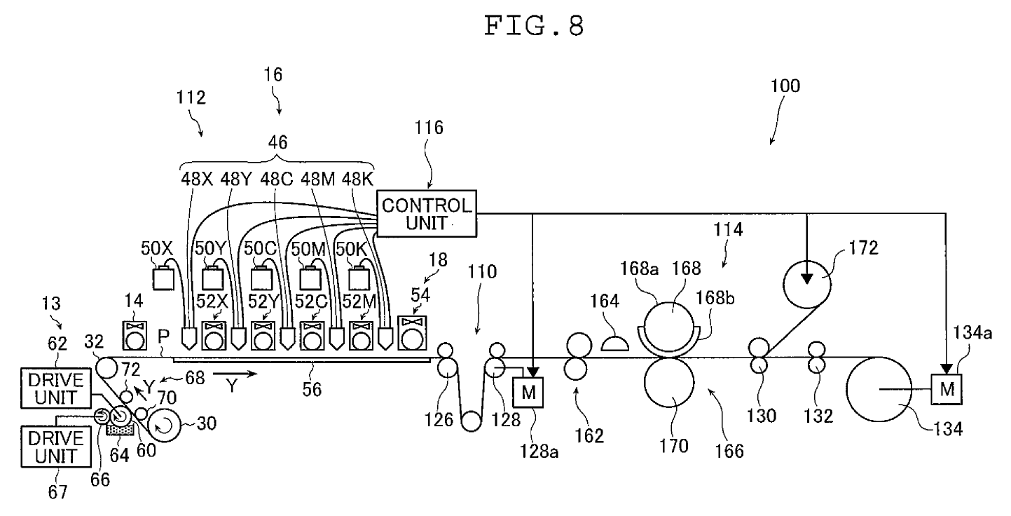

FIG. 8 is a front view showing, in simplified form, a digital label printer which uses an ink-jet recording device according to the invention, and FIG. 9 is a longitudinal sectional view of a recording medium P for printing labels such as may be used in the digital label printer shown in FIG. 8.

A digital label printer in the present embodiment records an image onto a web-type recording medium for printing labels at an image forming section, then makes label-shaped slits in the medium P with a die cutter in a post-treatment section. In addition, the printer carries out, as a subsequent step, a waste removal operation in which unnecessary portions of the pressure-sensitive adhesive sheet are peeled from the backing sheet (peel sheet) and removed.

In the example described below, an active ray curing-type digital label printer which uses a UV-curable ink as the active ray-curable ink that cures upon exposure to active rays is described by way of illustration. However, the invention is not limited in this regard, and may be applied to digital label printers which use any of various kinds of active ray-curable inks, as well as to any other type of digital label printer.

Referring to FIG. 9, a web-type recording medium P for printing labels (also referred to below as simply “recording medium P”) used in the present embodiment has a two-layer construction composed of a peel sheet 182 as a backing sheet on which is laminated a pressure-sensitive adhesive sheet 180 coated on the back side thereof with a pressure-sensitive adhesive 180a.

As shown in FIG. 8, a digital label printer 100 has a transport section 110; an undercoat forming section 13; an undercoating liquid semi-curing section 14; an image forming section 112 including an image recording section 16 and an image fixing section 18; a post-treatment section 114; and a control unit 116.

Here, the transport section 110 transports the web-type recording medium P for printing labels in a fixed direction (from left to right in FIG. 8). The image forming section 112 and the post-treatment section 114 are arranged in this order in the direction of travel of the recording medium P; that is, in the upstream to downstream direction, more specifically in the order of the undercoat forming section 13, the undercoating liquid semi-curing section 14, the image forming section 112 and the post-treatment section 114. Although partially not shown in FIG. 8, the control unit 116 is connected to the undercoat forming section 13, the undercoating liquid semi-curing section 14, the transport section 110, the image forming section 112 and the post-treatment section 114, and controls their respective operations.

The transport section 110 has a feed roll 30, a transport roll 32, transport roller pairs 126, 128, 130 and 132, a product roll 134, and transport motors 128a and 134a.

The feed roll 30 has the web-type recording medium P for printing labels wound thereon in the form of a roll.

The transport roll 32 and the transport roller pairs 126, 128, 130 and 132 are arranged in this order from the upstream to the downstream side of the travel path of the recording medium P. The transport roll 32 and the transport roller pairs 126, 128, 130 and 132 let out the recording medium P from the feed roll 30, and transport the recording medium P in a given direction (in the present embodiment, from left to right in FIG. 8).

As in the ink-jet recording device 10 described above, the transport roll 32 changes the travel path of the recording medium P from the obliquely upward direction to the horizontal direction.

The product roll 134, which is disposed the furthest downstream on the recording medium P travel path, i.e., in the direction of transport, takes up the recording medium P that has been transported over the travel path by the transport roll 32 and the transport roller pairs 126, 128, 130 and 132 and has passed through the undercoat forming section 13, the undercoating liquid semi-curing section 14, the image forming section 112, and the post-treatment section 114.

The transport motors 128a and 134a are connected to, respectively, the transport roller pair 128 and the product roll 134, and rotatably drive the transport roller pair 128 and the product roll 134.

That is, in the present embodiment, the transport roller pair 128 and the product roll 134 connected to the transport motors 128a and 134a, respectively, are driven to rotate and thus serve as the drive rollers for transporting the recording medium P. The other transport roller pairs 126, 130 and 132 and the transport roll 32 are driven rollers which rotate with movement of the recording medium P and regulate the recording medium P on the travel path.

In the transport section 110, the transport motors 128a and 134a rotatably drive the transport roller pair 128 and the product roll 134. Through this arrangement, the recording medium P is let out from the feed roll 30, passes through the undercoat forming section 13, the undercoating liquid semi-curing section 14, the image forming section 112, and the post-treatment section 114, and is taken up onto the product roll 134.

In the present embodiment, a transport buffer is provided between the image forming section 112 and the post-treatment section 114.

By providing such a transport buffer, it is possible to absorb slack that arises in a web-type recording medium P for printing labels due to a difference between the transport speed in the image forming section 112 and that in the post-treatment section 114, thus enabling the labels to be efficiently produced.

The transport motors 128a and 134a are connected to a subsequently described transport motor controller and their rotational speeds thereby controlled. This in turn controls the speed at which the web-type recording medium P for printing labels is transported by the transport section 110.

No particular limitation is imposed on the transport roller pairs which function as drive roller pairs. For example, transport motors may be provided for all the transport roller pairs so that all the transport roller pairs function as drive roller pairs.

As described above, the undercoat forming section 13 includes a coating roll 60, a drive unit 62, a reservoir 64, a scraper roll 66, a drive unit 67 and a positioning unit 68. The arrangement and function of each element of the undercoat forming section 13 are the same as those in the undercoat forming section 13 of the ink-jet recording device 10 as described above, and therefore their detailed description is omitted.

The coating roll 60 of the undercoat forming section 13 contacts the recording medium P as it is rotated in the direction opposite to the direction of travel of the recording medium P, whereby the undercoating liquid is applied onto the surface of the recording medium P.

The undercoat is thus formed on the surface of the recording medium P.

The undercoating liquid semi-curing section 14 is disposed on the downstream side of the undercoat forming section 13 in the direction of travel of the recording medium P. The layout and function of the undercoating liquid semi-curing section 14 in this embodiment are the same as those of the undercoating liquid semi-curing section 14 of the ink-jet recording device 10 described above and therefore their detailed description is omitted here.

The undercoating liquid semi-curing section 14 semi-cures the undercoat by irradiating with ultraviolet light the recording medium P which has the undercoat formed thereon through application of the undercoating liquid and which is transported by the transport section 110 to pass through the position opposed thereto.

The image forming section 112 includes the image recording section 16 and the image fixing section 18.

The image recording section 16 and the image fixing section 18 are configured in the same manner as the image recording section 16 and the image fixing section 18 of the ink-jet recording device 10 shown in FIG. 1 and therefore their detailed description is omitted.

The image recording section 16 includes a recording head unit 46 having recording heads 48X, 48Y, 48C, 48M and 48K, and the image fixing section 18 includes four UV irradiation units 52X, 52Y, 52C and 52M and a final UV irradiation unit for curing 54.

As above, the recording heads 48X, 48Y, 48C, 48M and 48K as well as the UV irradiation units 52X, 52Y, 52C, 52M and 54 are arranged, from the upstream to the downstream side in the direction of travel of the recording medium P, in the following order: recording head 48X, UV irradiation unit 52X, recording head 48Y, UV irradiation unit 52Y, recording head 48C, UV irradiation unit 52C, recording head 48M, UV irradiation unit 52M, recording head 48K and final UV irradiation unit for curing 54.

The image forming section 112 ejects ink droplets from each of the recording heads, then cures the ink droplets on the recording medium P by applying UV light from each of the UV irradiation units 52X, 52Y, 52C, 52M and 54, thereby forming an image.

The post-treatment section 114 is disposed on, in the recording medium P travel direction, the downstream side of the UV irradiation unit 54 corresponding to the recording head 48K. It has a varnish coater 162 and an UV irradiator 164 for coating the image surface with a clear, active ray-curable liquid (in the present embodiment, a clear, UV-curable liquid) and improving the gloss, a die cutter 166 for making label-shaped slits in the web-type recording medium P, and a waste roll 172 for peeling off unnecessary portions of the recording medium P.

As described above, the transport buffer is provided between the UV irradiation unit 54 corresponding to the recording head 48K and the varnish coater 162.

The varnish coater 162 is a clear liquid feeding means which feeds active ray- (in this embodiment, ultraviolet light-) curable clear liquid (referred to below as “active ray-curable clear liquid” or simply “clear liquid”) to the surface of the recording medium P, and which is situated on the downstream side, in the travel direction of the recording medium P, of the UV irradiation unit 54 corresponding to the recording head 48K.

The varnish coater 162 has a pair of coating rolls to the surface of which adheres (on which has been impregnated) a UV-curable clear liquid, and which rotate in accordance (synchronous) with movement of the recording medium P while nipping the recording medium P, thereby coating the surface of the foil-stamped recording medium P (the side on which an image has been formed) with the UV-curable clear liquid.

Here, the clear liquid coated by the varnish coater 162 is an active ray-curable clear liquid which can be cured by exposure to ultraviolet light. Exemplary clear liquids include cationic-polymerizable compositions, radical-polymerizable compositions and aqueous compositions which contain as the primary ingredients at least a polymerizable compound and a photoinitiator. The clear liquid is described in detail later in the specification.

The UV irradiator 164 is disposed on the downstream side of the varnish coater 162 in the travel direction of the recording medium P. The UV irradiator 164 irradiates the surface of the recording medium P with active rays (in this embodiment, ultraviolet light), thereby curing the UV-curable clear liquid that has been coated onto the surface of the recording medium P. The UV irradiator 164 may also adopt various layouts such as the one shown in the UV irradiation units 52X, 52Y, 52C, 52M and 54 described above.

The UV-curable clear liquid is coated onto the surface of the recording medium P and cured, enabling luster to be imparted to the image side of the recording medium P and making it possible to improve the image quality.

The die cutter 166 makes slits 180b of a desired label shape in only the pressure-sensitive adhesive sheet 180 of a printed, web-type recording medium P for printing labels, as shown in FIG. 9. The die cutter 166 is situated on the downstream side of the UV irradiator 164 in the travel direction of the recording medium P, and has a cylinder cutter 168 disposed on the image-forming side of the recording medium P and an anvil roller 170 disposed on the opposite side of the recording medium P from the cylinder cutter 168.

The cylinder cutter 168 is composed of a cylinder 168a and a plurality of slitting blades 168b which are wound around the cylindrical surface of the cylinder 168a and are formed according to the shape and arrangement of the labels.

The die cutter 166 preferably undergoes an intermittently rocking motion, that is, adjusts the rotational speed and rotational direction to form slits in the pressure-sensitive adhesive sheet 180.

The die cutter 166, while nipping the recording medium P between the cylinder cutter 168 and the anvil roller 170, undergoes an intermittently rocking rotation which is synchronous with the transport speed of the recording medium P, causing the slitting blades 168b to make label-shaped slits in only the pressure-sensitive adhesive sheet 180 of the recording medium P, thus producing labels in the recording medium with high efficiency.

The waste roll 172 peels from the peel sheet 182 and takes up unnecessary portions (label borders) of the pressure-sensitive adhesive sheet 180 which do not form labels (finished product) L.

The thus taken up recording medium P after unnecessary portions have been peeled, that is, the recording medium P in a state where only the labels L remain adhering to the peel sheet 182, is then taken up onto the product roll 134, giving the final product.

The control unit 116 has a memory which stores recording image data for ink ejection from the recording heads 48X, 48Y, 48C, 48M and 48K of the recording head unit 46, a head drive controller for controlling the drive of the recording heads 48X, 48Y, 48C, 48M and 48K of the recording head unit 46 based on the recording image data, an image data analyzer for analyzing the shapes of the labels L based on the image data stored in the memory, a transport speed changer for changing the transport speed of the web-type recording medium P for printing labels based on the shapes of the labels L analyzed by the image data analyzer, the transport motor controller for controlling the rotational speed of the transport motors 128a and 134a based on the transport speed changed by the transport speed changer, and a die cutter controller for controlling the rotational speed of the die cutter 166 based on the transport speed changed by the transport speed changer. The control unit 116 adjusts the timing at which ink droplets are ejected from each recording head, the amount of ejection, the speed at which the recording medium is transported by the transport section 110, and the timing at which the recording medium is cut with the die cutter.

Next, a method for producing labels with the digital label printer 100 is described.

Referring to FIG. 8, the recording medium P that has been let out from the feed roll 30 onto which it is wound into a roll is transported by the transport section 110 to the image forming section 112 after the undercoating liquid has been applied with the coating roll 60 of the undercoat forming section 13 and the undercoat has been semi-cured in the undercoating liquid semi-curing section 14.

The recording medium P transported to the image forming section 112 passes through the positions opposite the recording heads 48X, 48Y, 48C, 48M and 48K.

The recording heads 48X, 48Y, 48C, 48M and 48K eject, under control by the control unit 116, droplets of UV-curable ink onto the recording medium P passing through positions opposed thereto. The recording medium P onto which the ink has been ejected then travels further and passes through positions opposite the corresponding UV irradiation units 52X, 52Y, 52C, 52M and 54, where it is irradiated with ultraviolet light, thereby curing the ink.

That is, when the recording medium P passes through positions opposite the recording heads 48X, 48Y, 48C, 48M and 48K, ink droplets are ejected onto the recording medium P from the recording heads 48X, 48Y, 48C, 48M and 48K. The recording medium P is subsequently exposed to ultraviolet light from the UV irradiation units 52X, 52Y, 52C, 52M, causing the ink to cure. After the image formation with the recording head 48K, ultraviolet light is emitted from the final UV irradiation unit for curing 54 to ensure curing of the various inks and undercoating liquid. An image is thus formed on the surface of the recording medium P.

The recording medium P on which images have been formed is transported through the transport buffer to the post-treatment section 114, where a UV-curable clear liquid is applied by the varnish coater 162 to the surface of the recording medium P, then is cured by the UV irradiator 164.

The recording medium P that has been coated with the UV-curable clear liquid is transported to the die cutter 166, where slits 180b in the shape of labels L are made only in the pressure-sensitive adhesive sheet 180 by means of the cylinder cutter 168 and the anvil roller 170.

At this time, because the die cutter 166, as noted above, makes slits 180b in the shape of labels L while intermittently rocking, the slits 180b can be continuously formed. Waste from the recording medium P can thus be minimized.

Unnecessary portions (portions other than the labels L) of the pressure-sensitive adhesive sheet 180 of the recording medium P are peeled from the peel sheet 182 and taken up onto the waste roll 172. The recording medium P on which only the labels L remain affixed to the peel sheet 182 is taken up onto the product roll 134, thereby giving a final product.

Labels are produced by the procedure described above.

In this way, use of the above-described various fluorescent lamps for the fluorescent lamps of the UV irradiation units enables the digital label printer 100 as well to semi-cure or cure the inks and the undercoating liquid in a short period of time without relying on an expensive, high-power fluorescent lamp, thus achieving a higher production rate. Nozzle clogging is also prevented from occurring in the recording heads of the image forming section. Therefore, high-resolution and high-quality labels can be consistently and rapidly produced for a long period of time.

Moreover, the digital label printer 100 of the present embodiment carries out peel processing in which the transport speed changer, based on label shape data, slows the transport speed of the recording medium P at positions of label portions which are vulnerable to the peeling of unnecessary portions, thereby preventing the breakage or rupture of the labels L during post-treatment (waste removal) and enabling the reliable removal of unnecessary portions other than the label portions. In this way, halting of the apparatus due to the breakage or rupture of labels L is eliminated, enhancing productivity and making it possible to inexpensively provide labels L.

In the present embodiment, label-shaped slits are made with the die cutter in the post-treatment section, but the die cutter may be replaced by a laser cutter to make slits 180b of a desired label shape in only the pressure-sensitive adhesive sheet 180 of a printed, web-type recording medium P for printing labels.

The undercoat forming section 13 integrated with the image forming section 112 and the post-treatment section 114 may be provided in the digital label printer as independent and discrete apparatuses. In other words, the digital label printer may include a front-end processing unit having an undercoat forming section and an image forming section and a back-end processing unit having a post-treatment section and be operated as follows: An image is formed on the recording medium in the front-end processing unit, after which the recording medium is taken up; then, the recording medium having the image formed thereon is set on the back-end processing unit, where slits are made in the recording medium and unnecessary portions are taken up to obtain a product.

Next, use may be made of various recording media, undercoating liquids and inks in the ink-jet recording device of the present invention.

The recording medium used in the ink-jet recording device of the present invention may be a permeable recording medium, an impermeable recording medium or a slowly permeable recording medium.

Illustrative examples of permeable recording media include plain paper, porous paper, and other recording media capable of absorbing liquids. Illustrative examples of impermeable or slowly permeable recording media include art paper, synthetic resin, rubber, resin-coated paper, glass, metal, ceramic and wood. In the practice of the invention, composite recording media in which a plurality of these materials are combined may also be used for the purpose of adding the functionality thereof.

The ink, which has at least a composition suitable for forming images, includes at least one polymerizable or crosslinkable material, and optionally includes as well a polymerization initiator, a hydrophilic solvent, a colorant and other ingredients. Use may be made of one that cures upon exposure to active energy rays.

The undercoating liquid includes at least one polymerizable or crosslinkable material, and optionally includes as well a polymerization initiator, a hydrophilic solvent, a colorant and other ingredients. It is preferable for the undercoating liquid to be formulated so as to have a different composition than the ink.

The polymerization initiator is a compound which is capable of initiating a polymerization reaction or crosslinking reaction under the influence of active energy rays. An undercoating liquid that has been applied to the recording medium can in this way be cured by exposure to active energy rays.

The undercoating liquid preferably includes a radical-polymerizable composition. As used herein, “radical-polymerizable composition” refers to a composition which includes at least one radical-polymerizable material and at least one radical polymerization initiator. Because the undercoating liquid includes a radical-polymerizable composition, the undercoating liquid curing reaction can be carried out at a high sensitivity in a short period of time.

Moreover, it is preferable for the ink to include a colorant. It is preferable for the undercoating liquid which is used in combination with this ink to either have a composition that includes no colorant or includes less than 1 wt % of colorant, or to have a composition that includes a white pigment as the colorant.

Although the ink-jet recording device of the present invention has been described above in detail, it should be noted that the present invention is by no means limited to the foregoing embodiments and various improvements and modifications can be made without departing from the spirit and scope of the present invention.

For example, a phosphor emitting UV light is used for the phosphor film in the above-described embodiment, because the device can be manufactured at a lower cost and UV-curable inks and undercoating liquid are used. However, this is not the sole case of the present invention and the phosphor used may be one that emits light having such a wavelength that an active energy ray-curable ink and/or undercoating liquid used as the ink and/or undercoating liquid cures.

Because a higher-resolution image can be recorded, the ink-jet recording device in the above-described embodiment is provided with the undercoat forming section to form an undercoat on the recording medium before forming an image thereon. However, an image may be directly formed on the recording medium having no undercoat formed thereon without providing the ink-jet recording device with the undercoat forming section.

What is claimed is:

1. An ink-jet recording device comprising:
transport means for transporting a recording medium;
image forming means which includes at least one ink-jet head that ejects, based on image signals, ink containing at least a colorant and cured by exposure to active energy rays onto said recording medium transported by said transport means and moved to a position opposed to said at least one ink-jet head; and
image curing means which includes at least one light irradiation unit having a fluorescent lamp from which the active energy rays are emitted, and which cures the ink deposited on said recording medium by irradiation of an image formed on said recording medium with the active energy rays from said at least one light irradiation unit,
wherein said fluorescent lamp has a bulb, a reflective film formed on a large part of an inner wall of said bulb and having a first aperture formed on a side of said recording medium, and a phosphor film formed on said reflective film and a part of said inner wall of said bulb and having a second aperture formed on the side of said recording medium, and
wherein formulas: β<α, 60°≦α≦150° and 30°≦β≦90° where α represents a first aperture angle of said first aperture for said reflective film and β represents a second aperture angle of said second aperture for the phosphor film, are satisfied.

2. The ink-jet recording device according to claim 1, wherein said reflective film has a transmittance of not more than 10%.

3. An ink-jet recording device comprising:
transport means for transporting a recording medium;
image forming means which includes at least one ink-jet head that ejects, based on image signals, ink containing at least a colorant and cured by exposure to active energy rays onto said recording medium transported by said transport means and moved to a position opposed to said at least one ink-jet head; and
image curing means which includes at least one light irradiation unit having a fluorescent lamp from which the active energy rays are emitted, and which cures the ink deposited on said recording medium by irradiation of an image formed on said recording medium with the active energy rays from said at least one light irradiation unit,
wherein said fluorescent lamp has a bulb, a reflective film formed on a large part of an inner wall of said bulb and having a first aperture formed on a side of the recording medium, and a phosphor film formed on said reflective film and a part of said inner wall of said bulb and having a second aperture formed on the side of said recording medium, and
wherein said reflective film has a transmittance of not more than 10%.

4. The ink-jet recording device according to claim 1, wherein said first aperture of said reflective film and said second aperture of said phosphor film are symmetric with respect to a axial plane connecting a centre of said fluorescent lamp with said recording medium.

5. The ink-jet recording device according to claim 1, wherein said at least one light irradiation unit further includes a housing which is disposed so as to surround said fluorescent lamp and has an opening formed on the side of said recording medium.

6. The ink-jet recording device according to claim 1, wherein said at least one ink-jet head is of a full-line type in which said at least one ink-jet head has a length in a direction perpendicular to a direction of travel of said recording medium which is larger than a width of said recording medium and ink droplets can be ejected over a whole area of said recording medium in the direction perpendicular to the direction of travel of said recording medium.

7. The ink-jet recording device according to claim 1,
wherein said at least one ink-jet head of said image forming means comprises at least two ink-jet heads from which inks of different colors are ejected, and
wherein said at least one light irradiation unit of said image curing means comprises at least one light irradiator disposed between adjacent ink-jet heads of said at least two ink-jet heads in a direction of travel of said recording medium and a final light irradiator which irradiates the active energy rays onto images formed on said recording medium.

8. The ink-jet recording device according to claim 7, wherein said final light irradiator is configured as in said at least one light irradiator.

9. The ink-jet recording device according to claim 7, wherein said final light irradiator comprises a metal halide lamp or a high-pressure mercury vapor lamp.

10. The ink-jet recording device according to claim 7,
wherein said at least one light irradiator disposed between said adjacent ink-jet heads of said at least two ink-jet heads semi-cures ink constituting an image formed by an ink-jet head located upstream of said at least one light irradiator in the direction of travel of said recording medium, and
wherein said final light irradiator cures inks of the images formed on said recording medium.

11. The ink-jet recording device according to claim 1, further comprising:
undercoating liquid applying means which is disposed upstream from said image forming means in a direction of travel of said recording medium transported by said transport means and which applies to said recording medium undercoating liquid that cures upon exposure to the active energy rays; and
undercoating liquid semi-curing means which is disposed downstream of said undercoating liquid applying means in the direction of travel of said recording medium and which includes a light irradiation unit, said undercoating liquid applied onto said recording medium being irradiated with active energy rays from said light irradiation unit to semi-cure said undercoating liquid applied on said recording medium.
